(19) United States
(12) Patent Application Publication
(10) Pub. No.: US 2007/0273741 A1
(43) Pub. Date: Nov. 29, 2007

(54) Image forming apparatus

(75) Inventor: Hideki Kashimura, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/604,025

(22) Filed: Nov. 24, 2006

(30) Foreign Application Priority Data
May 23, 2006 (JP) 2006-142807

(51) Int. Cl. B41J 2/41; G11B 3/00

(52) U.S. Cl. 347/112

(57) ABSTRACT

An image forming apparatus comprises an image retention medium, a charging unit, a latent image forming unit, a developing unit that uses a toner holding a color forming or non-color forming state with the application of color forming information by light, a color forming information application unit, a transfer unit, and a color forming unit.

### BACKGROUND

1. Technical Field

The present invention relates to an electrostatic recording type image forming apparatus.

2. Related Art

In a recording apparatus that obtains color images by an electrophotography system, the three primary colors are developed according to image information, and toner images are sequentially superimposed so as to obtain color images. As specific configurations of the device, there is known a so-called four-cycle type apparatus that, for each color, a latent image formed by an image forming method is developed for each color on a single photoreceptor drum and then the developed image is transferred to a transfer member. In the four-cycle type apparatus, the development and transfer are repeatedly performed so as to obtain color images. Further, there is known a tandem type apparatus that has a photoreceptor drum and a developing device for each image forming unit for each color. In the tandem type apparatus, toner images are sequentially and continuously transferred by movement of a transfer member so as to obtain color images.

The apparatuses are at least common in that plural developing devices corresponding to each of the colors are provided. For this reason, for color image formation, four developing devices corresponding to the three primary colors and black are required. Further, in the tandem type apparatus, four photoreceptor drums according to the four developing devices are required, and a unit for regurating the synchronicity of the four image forming units is required. Accordingly, the apparatus cannot avoid being large, and cost increasing.

### SUMMARY

According to an aspect of the present invention, there is provided an image forming apparatus comprising:

an image retention medium that has a conductive substrate, a photosensitive layer, and a surface layer sequentially laminated from an inner peripheral surface toward an outer peripheral surface;

a charging unit that charges the outer peripheral surface of the image retention medium at a predetermined charging potential;

a latent image forming unit that has a first light source that emits light in a direction from the inner peripheral surface of the image retention medium toward the outer peripheral surface, and exposes from the inner peripheral surface of the image retention medium charged by the charging unit to the light emitted from the first light source so as to form an electrostatic latent image on the outer peripheral surface of the image retention medium;

a developing unit that develops the electrostatic latent image formed on the outer peripheral surface of the image retention medium with a toner so as to form a toner image on the outer peripheral surface of the image retention medium, the toner holding a color forming state or a non-color forming state by the application of color forming information by light;

a color forming information application unit that has a second light source that emits light in a direction from the outer peripheral surface of the image retention medium toward the inner peripheral surface, and exposes the toner image formed on the outer peripheral surface of the image retention medium to the light emitted from the second light source so as to apply color forming information to the toner image;

a transfer unit that transfers the toner image to a recording medium;

a fixing unit that fixes the toner image transferred to the recording medium onto the recording medium;

a color forming unit that forms color of the toner image applied with the color forming information; and

the conductive substrate being substantially permeable to at least the light emitted from the first light source, and the surface layer being substantially impermeable to at least the light emitted from the second light source.

### BRIEF DESCRIPTION OF THE DRAWINGS

Exemplary embodiments of the present invention will be described in detail based on the following figures, wherein:

FIG. 1 is a schematic block diagram showing an example of an image forming apparatus of the aspect of the invention;

FIG. 2 is a schematic view showing an example of the configuration of a color forming information application device of the image forming apparatus of the aspect of the invention;

FIG. 3 is a schematic view showing the electrical configuration of an image forming apparatus 10;

FIG. 4 is a schematic view showing the configuration of a photoreceptor;

FIG. 5A is a schematic view showing a state where exposure is performed to form an electrostatic latent image on the photoreceptor;

FIG. 5B is a schematic view showing a state where a toner image is formed on the photoreceptor;

FIG. 5C is a schematic view showing a state where exposure is performed to apply color forming information to the photoreceptor;

FIG. 6 is a schematic view showing a state where exposure is performed to apply color forming information to the photoreceptor;

FIG. 7A is a schematic view illustrating a color forming mechanism of a toner and showing a color forming portion; and

FIG. 7B is a schematic view illustrating a color forming mechanism of a toner and showing a color forming portion on a magnified scale.

### DETAILED DESCRIPTION

Hereinafter, an aspect of the present invention will be described in detail.

The toner used in the aspect of the invention has a functionality of, when each particle of the toner is exposed to light having different wavelengths, maintaining a color formable state to a color corresponding to each wavelength or a state not to form color (non-color forming). That is, in the toner is provided a color forming material (or color forming portions including color forming material) forming colors by the application of the color forming information by light. The toner is controlled to maintain the color forming or non-color forming state with the application of the color forming information by light.

Here, “the application of the color forming information by light” means that light selectively having one or more specified wavelengths is applied to a desired region of the toner image or no light is applied in order to control the color forming/non-color forming state per indivisual toner particles constituting the toner image or a color tone upon color forming.

When the color forming information is applied by the light exposure, the individual toners constituting the toner image keep the color formable state to a color according to light having the wavelength of exposure light or a non-color forming state where the color according to light having the wavelength of exposure light is not formed.

The toner at least includes two kinds of reactive components (referred to as first and second components) that react with each other so as to form a color as a color forming material, and a color forming portion (described below in detail) including the color forming material. The toner keeps the color formable state or the non-color formable state with the application of the color forming information by light and then forms colors by heating.

In the toner used in the aspect of the invention, the first and second components are included in different matrixes where mutual material diffusion between regions rarely occurs unless the color forming information is applied. That is, the first and second components exist to be separated from each other.

Specifically, the first component of the two kinds of reactive components is included in a first matrix, and the second component is included in a matrix (second matrix) other than the first matrix. Further, a partitioning wall is preferably provided between the first and second matrixes. The partitioning wall obstructs material diffusion between both matrixes. When an external stimulus, such as heat or the like, is applied, the partitioning wall allows material diffusion between both matrixes according to the kind or intensity of the stimulus, or a combination of them.

To arrange the two kinds of reactive components in the toner using such a partitioning wall, a microcapsule is preferably used. Of the two kinds of reactive components in the toner, one of the first and second components may be included inside the microcapsule and the other may be included outside the microcapsule.

Moreover, when the first component is included inside the microcapsule and the second component is included outside the microcapsule, the inside of the microcapsule corresponds to the first matrix, and the outside of the microcapsule corresponds to the second matrix.

The microcapsule has a core and an outer shell that surrounds the core. The microcapsule is not particularly limited. What is necessary is that the material diffusion between the inside and outside of the microcapsule is obstructed unless the external stimulus, such as heat or the like, is applied, and, when the external stimulus is applied, the material diffusion between the inside and outside of the microcapsule is allowed according to the kind or intensity of the stimulus, or the combination of them. Moreover, in the core, at least one of the reactive components is included.

The microcapsule allows the material difflusion between the inside and outside of the microcapsule upon the application of the stimulus, such as light irradiation or pressure. More preferably, the microcapsule is a thermoresponsive microcapsule that allows the material diffusion between the inside and outside of the microcapsule by a heating treatment (increases material permeability of the outer shell).

The material diffusion between the inside and outside of the microcapsule when the stimulus is applied is preferably irreversible in view of suppressing a decrease in a color forming density upon image formation or suppressing a change in color balance of an image left under a high-temperature environment.

Accordingly, the outer shell of the microcapsule preferably has a function of irreversibly increasing material permeability by softening, decomposition, dissolution (compatibility with peripheral members), or deformation with the application of the stimulus, such as heating treatment or light irradiation.

As the toner used in the aspect of the invention, any toner may be used insofar as it exhibits the above-described function. For example, the toners described in JP-A No. 63-311364 and JP-A No. 2003-330228 may be exemplified, but a toner described below is preferably used in view of allowing many microcapsules to exist in the toner and suppressing maldistribution of the microcapsules.

In the aspect of the invention, as described above, the toner that keeps the color formable state or the non-color formable state with the application of the color forming information by light preferably includes a toner (hereinafter, referred to as “F toner”) that has the first and second components existing to be separated from each other and color forming when they react with each other, and the light curing composition including either the first component or the second component. The F toner allows the light curing composition to keep a cured or non-cured state with the application of the color forming information by light so as to keep the color formable state or the non-color formable state.

First, a color forming mechanism of the F toner used in the aspect of the invention will be described.

In the aspect of the invention, the toner is applied with the color forming information by light, which is called a color forming portion, in a binder resin, as described below. The toner has one or more continuous regions where the color formable state to a specified single color or the state not color forming to the specified single color (that is, the non-color forming state) is kept.

Moreover, when a plural color forming portions are included in the toner, the plural color forming portions are provided to be separated from each other such that materials therein are not mixed.

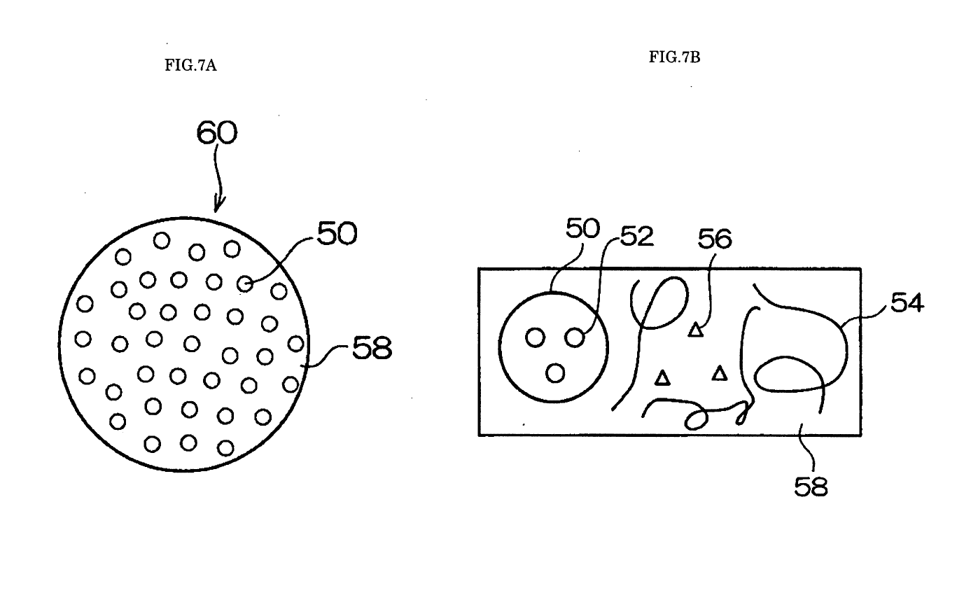

As such, the toner of the aspect of the invention has one or a plural color forming portions as one of plural continuous regions where the color formable state or the non-color formable state to different colors is kept. As shown in FIG. 7A, each of the color forming portion 60 has the microcapsules 50 containing a color forming agent and the light curing composition 58 encircling the microcapsules 50. That is, in the color forming portion 60, the microcapsules 50 are dispersed into the light curing composition 58.

As shown in FIG. 7B that shows the color forming portion 60 on a magnified scale, the color forming portion 60 at least includes the microcapsules 50, color forming agents (the first component) 52, developing monomers (the second component) 54 having a polymerizable functional group that are close to or come into contact with the color forming agents 52 so as to cause the color forming agents 52 to form colors, and photopolymerization initiators 56.

Each of the microcapsules 50 at least contains the color forming agents (the first component) 52 therein. The developing monomers (the second component) 54 having the polymerizable functional group that are close to or come into contact with the color forming agents (the first component) 52 so as to cause the color forming agent 52 to form colors, and the photopolymerization initiators 56 are included in the light curing composition 58 that encapsulates the microcapsules 50.

As the color forming agents (the first component) 52, a triaryl-based leuco compound which is excel in brightness of a color forming hue or the like is appropriately used.

As the developing monomers 54 that causes the color forming agents 52, such as the leuco compound (electron donating) or the like, to form the colors, an electron-accepting compound is preferably used. As the developing monomers 54, in particular, a phenol-based compound is generally used. The developing monomers 54 may be appropriately selected from developers that are used in a thermosensitive paper or a pressure-sensitive paper.

The electron donating color forming agent 52 and the electron accepting developing monomer 54 are under an acid-base reaction so as to cause the color forming agent 52 to form colors.

As the photopolymerization initiators 56, a spectral sensitization dye that generates a polymerizable radical serving as a trigger for sensitizing visual light and polymerizing the developing monomer 54 is used.

For example, as for exposure of three primary colors of red (R), green (G), and blue (B), a reaction promoter of the photopolymerization initiator 56 is used such that the developing monomer 54 progresses a sufficient polymerization reaction. For example, when an ion complex including a spectral sensitization dye (cation) absorbing exposure light and a boron compound (anion) is used, the spectral sensitization dye is optically excited by exposure and electrons are moved to the boron compound, such that a polymerizable radical is generated and polymerization starts.

By combining these materials, as the photosensitive color forming portion 60, it may be possible to obtain color forming recording sensitivity of about 0.1 to 0.2 mJ/cm².

Due to presence/absence of light irradiation for the application of the color forming information to the color forming portion 60 having the above-described configuration, the color forming portion 60 has a polymerized developer compound or a non-polymerized developing monomer 54.

After the color forming information is applied, when a treatment, such as heating or the like, is performed, in the color forming portion 60 having the non-polymerized developing monomer 54, the developing monomer 54 migrates by heat or the like and passes through a void of the partitioning wall of the microcapsule 50, and is diffused into the microcapsule. As described above, since the color forming agent 52 is basic and the developing monomer 54 is acid, the developing monomer 54 and the color forming agent 52 that are diffused into the microcapsule 50 are under the acid-base reaction such that the color forming agent 52 forms the colors.

Meanwhile, the polymerized developer compound may not be diffused and pass through the void of the partitioning wall of the microcapsule 50 due to a bulk by polymerization in a subsequent color forming process by heating or the like. Then, the polymerized developer compound may not react with the color forming agent 52 in the microcapsule, and thus color forming may not be performed. Therefore, the microcapsule 50 remains colorless. That is, the color forming portion 60, onto which light having a specified wavelength is irradiated, exists while not forming the color.

After color forming, the entire surface is exposed to a white light source at an appropriate step, and the remaining non-polymerized developing monomers 54 all are polymerized, such that stable image fixing is performed. Further, the decomposition of the remaining spectral sensitization dye results in decolorizing of a ground color. Moreover, the spectral sensitization dye of the photopolymerization initiator 56 corresponding to a visible region remains at the last with the tone of the ground color, but decolorizing of the spectral sensitization dye may be performed using a light decolorizing phenomenon of a color/boron compound. That is, when the electrons are moved from the optically excited spectral sensitization dye to the boron compound, the polymerizable radical is generated, and the radical causes the polymerization of the monomer. Further, the radical reacts with a dye radical so as to cause color decomposition of the dye. As a result, it may be possible to decolorize the dye.

In the F toner, the color forming portions 60 that form different colors (for example, yellow (Y), magenta (M), and cyan (C)) may be formed and used as one microcapsule in a state where each of the developing monomers 54 does not interfere with a developer other than a target developer 52 (in a state where they are separated from one another). That is, when a plural color forming portions including the color forming agents 52 forming different colors are included in the same toner, the plural color forming portions are provided in such a state that materials included therein are not mixed with one another.

In the toner, a spacein a color forming portion 60 other than the microcapsules 50 including the electron donating color forming agents 52 is buried with the electron accepting developing monomers 54 and the light curing composition 58. Since light is irradiated onto such a color forming portion 60, quality of light-receiving efficiency in one toner particle is overwhelmingly high compared with the toner disclosed in JP-A No. 2003-330228.

In addition, as described above, since a color forming information application mechanism is not a reversible reaction, there is no temporal limitation to color forming by heating. Therefore, printing at a low-speed region may be performed, that is, a wide speed range may be handled. In addition, a degree of freedom for an arrangement place of the fixing unit where color forming by heating is performed is high.

The F toner used in the aspect of the invention will be described in more detail.

As for the F toner used in the aspect of the invention, the following three aspects are exemplified.

Preferably, the F toner is one of the three kinds of toners; a toner including the first and second components that react with each other to form colors, the light curing composition, and the microcapsules that are dispersed into the light curing composition, wherein the first component is included in the microcapsules, and the second component is included in the light curing composition (first aspect); a toner including first and second components that react with each other to form colors, and microcapsules including a light curing composition, wherein the first component is included outside the microcapsules, and the second component is included inside the light curing composition (second aspect); a toner including first and second components that react with each other to form colors, one microcapsules including the first component, and the other microcapsules including a light curing composition, into which the second components are dispersed (third aspect).

Of the three aspects, the first aspect is preferable in view of stability before the application of the color forming information by light, the control of color forming, and the like. Moreover, in the following description of the toner, a description will be given on the basis of the first aspect, the configuration, material, and preparing method of the toner of the first aspect may be used and applied to the toner of the second aspect or the third aspect.

Moreover, the F toner that uses the combination of the thermoresponsive microcapsule and the light curing composition is more preferably one of the following two types.

(1) A type of toner in which material diffusion of the second component included in a non-cured light curing composition is suppressed even though the light curing composition is heated in a non-cured state and, when a heating treatment is performed after the light curing composition is cured by light irradiation for the application of the color forming information, material diffusion of the second component included in the light curing composition after curing is promoted (hereinafter, referred to as “photochromic toner”).

(2) A type of toner in which material diffusion of the second component included in a non-cured light curing composition is promoted when the heating treatment is performed in a state where the light curing composition is not cured (a state where the second component is not polymerized) and material diffusion of the second component included in the light curing composition after curing is suppressed when the heating treatment is performed after the light curing composition is cured by light irradiation for the application of the color forming information (after the second component is polymerized) (hereinafter, referred to as “nonphotochromic toner”).

The main difference between the photochromic toner and the nonphotochromic toner is in material constituting the light curing composition. In the photochromic toner, at least a second component (nonphotopolymerizable) and a photopolymerizable compound are included in the light curing composition. In contrast, in the nonphotochromic toner, at least a second component containing a photopolymerizable group in a molecule is included in the light curing composition.

Moreover, in the light curing compositions used in the photochromic toner and the nonphotochromic toner, a photopolymerization initiator is preferably included. If necessary, other kinds of materials may be included.

For use as the photopolymerizable compound and the second component used in the photochromic toner, materials that: in a state where the light curing composition is not cured, interact with each other to suppress the material diffusion of the second component in the light curing composition; and, in a state after the light curing composition is cured (polymerization of the photopolymerizable compound) by light irradiation for the application of the color forming information, the interaction between both materials is decreased, and thus the material diffusion of the second component in the light curing composition is easily made.

Therefore, in the photochromic toner, before a process of allowing the toner to form the colors by the heating treatment is performed, light having a wavelength curing the light curing composition is irradiated in advance for the application of the color forming information, and thus the material diffusion of the second component included in the light curing composition is easily made. For this reason, when heating treatment is performed, the first component in the microcapsule and the second component in the light curing composition react with each other (color forming reaction) by the dissolution of the outer shell of the microcapsule or the like.

To the contrary, even though the heating treatment is performed for the application of the color forming information in a state where light having the wavelength curing the light curing composition is not irradiated, the second component is trapped in the photopolymerizable compound, such that the second component may not come into contact with the first component in the microcapsule. As a result, the reaction (color forming reaction) between the first component and the second component does not occur.

As described above, in the photochromic toner, for the application of the color forming information, according to a combination of the presence/absence of irradiation of light having a wavelength in a specified wavelength region curing the light curing composition and the heating treatment, it may be possible to control the reaction (color forming reaction) between the first component and the second component. As a result, it may be possible to control color forming of the toner.

In addition, in the nonphotochromic toner, since the second component itself has photopolymerizability, even though light is irradiated for the application of the color forming information, when the wavelength of light is not in the specified wavelength region curing the light curing composition, the material diffusion of the second component included in the light curing composition is kept to be easily made. Therefore, in this state, when the heating treatment is performed, the outer shell of the microcapsule is dissolved, and then the first component in the microcapsule and the second component in the light curing composition react with each other (color forming reaction).

To the contrary, when light having a wavelength in the specified wavelength region curing the light curing composition before the heating treatment, the second components included in the light curing composition are polymerized, such that the material diffusion of the second component included in the light curing composition becomes difficult. For this reason, even though the heating treatment is performed, the second component may not come into contact with the first component in the microcapsule, such that the reaction (color forming reaction) between the first component and the second component does not occur.

As described above, in the nonphotochromic toner, for the application of the color forming information, according to a combination of the presence/absence of irradiation of light having a wavelength in a specified wavelength region curing the light curing composition and the heating treatment, it may be possible to control the reaction (color forming reaction) between the first component and the second component. As a result, it maybe possible to control color forming of the toner.

Next, an appropriate structure of the F toner will be described in detail. Here, it is assumed that the toner includes the light curing composition and the microcapsules that are dispersed into the light curing composition.

In this case, the toner may have only one color forming portion that includes the light curing composition and the microcapsules dispersed into the light curing composition, however, preferably have two or more color forming portions.

The “color forming portion” used herein means a continuous region where one specified color is formed when the external stimulus is applied, as described above.

Moreover, when two or more color forming portions are included in the toner, one kind of color forming portions that may form the same color may be included in the toner. More preferably, however, two or more kinds of color forming portions that may form different colors are included in the same toner. This is because colors to be formed in one toner particle is limited to one kind in the former case, but two or more kinds of colors may be formed in the latter case.

For example, as two or more kinds of color forming portions that may form different colors, a combination of a yellow color forming portion forming yellow, a magenta color forming portion forming magenta, and a cyan color forming portion forming cyan may be exemplified.

In this case, for example, when one kind of color forming portions form the color by the application of the external stimulus, the toner may form one color of yellow, magenta, and cyan. Further, when two kinds of color forming portions form the colors, a color according to a combination of the colors formed by two kinds of color forming portions may be formed. That is, various colors may be expressed by one toner particle.

Moreover, the control of the color to be formed when two or more kinds of color forming portions forming different colors are included in the toner may be realized by varying the kinds or the combination of the first and second components included in the individual color forming portions or by varying the wavelengths of light used for curing the light curing compositions included in the individual kinds of color forming portions.

That is, in this case, since the wavelength of light required for curing the light curing composition included in the color forming portion for each kind of color forming portion is varied, various kinds of light having different wavelengths according to the kinds of color forming portions (in detail, the light curing compositions of the color forming portions) may be used for the application of the color forming information.

In order to vary the wavelength of light required for curing the light curing composition included in the color forming portion, a photopolymerization initiator sensitive to light having a different wavelength for each kind of the color forming portion is preferably contained in the light curing composition.

For example, when three kinds of color forming portions forming yellow, magenta, and cyan are included in the toner, and when the wavelength is gradually changed with the same light amount, materials that have the most cured states when light having any of the wavelengths of 405 nm, 532 nm, and 657 nm are irradiated are used as the light curing compositions included in the individual kinds of color forming portions. Then, the toner may be allowed to form a desired color by changing the wavelength of light to be irradiated. Moreover, the wavelength of light to be irradiated onto the toner may be selected from a visible region or an ultraviolet region.

The toner used in the aspect of the invention may be one that includes a base material primarily containing the same binder resin as that used in a toner using a colorant, such as a known pigment or the like. In this case, the two or more color forming portions are preferably dispersed into the base material as particulate capsules (hereinafter, a one capsular color forming portion may be referred to as “photosensitive/thermosensitive capsule”). Further, a releasing agent or various additives may be included in the base material, like the toner using the colorant, such as the known pigment or the like.

The photosensitive/thermosensitive capsule has a core that includes a microcapsule or light curing composition, and an outer shell that covers the core. The outer shell is not particular limited insofar as it may stably hold the microcapsule or light curing composition in the photosensitive/thermosensitive capsule during a process of producing a toner or upon keeping the toner such that the microcapsule or light curing composition does not leak outside the photosensitive/thermosensitive capsule.

However, in the aspect of the invention, in a process of producing a toner described below, in order to prevent the second component from passing through the outer shell and leaking a matrix outside the photosensitive/thermosensitive capsule and to prevent the second component in another photosensitive/thermosensitive capsule forming a different color from passing through the outer shell and flowing therein, preferably, the outer shell primarily contains a binder resin composed of a water insoluble resin or a water insoluble material, such as a releasing material.

Next, the toner forming materials that are used in the F toner or materials/methods that are used when the toner forming materials are adjusted will be described below in detail.

In this case, at least the first component, the second component, the microcapsules including the first component, and the light curing composition including the second component are used in the toner. More preferably, the photopolymerization initiator is included in the light curing composition. Further, various additives and the like may be included. In addition, the first component may exist in the microcapsule (core) in a solid state or may exist together with a solvent.

Moreover, in the nonphotochromic toner, an electron donating colorless dye or a diazonium salt compound is used as the first component, and an electron accepting compound having a photopolymerizable group or a coupler compound having a photopolymerizable group is used as the second component. Further, in the photochromic toner, an electron donating colorless dye is used as the first component, an electron accepting compound (also referred to as “electron accepting developer” or “developer”) is used as the second component, and a polymerizable compound having etylenically unsaturated bond is used as the photopolymerizable compound.

In addition to the materials described above, the same materials as those forming a toner using a known colorant, that is, a binder resin, a releasing agent, an internal additive, and an external additive may be appropriately used, if necessary. Hereinafter, the individual materials will be described in detail.

—First Component and Second Component—

As a combination of the first component and the second component, the following combinations (a) to (r) may be appropriately exemplified (in the followings, the former is the first component and the latter is the second component).

(a) A combination of an electron donating colorless dye and an electron accepting compound.

(b) A combination of a diazonium salt compound and a coupling component (hereinafter, arbitrarily referred to as “coupler compound”).

(c) A combination of an organic acid metal salt, such as behenate silver or silver stearate, and a reducing agent, such as protocatechinic acid, spiroindane, or hydroquinone.

(d) A combination of a long-chain fatty acid iron salt, such as ferric stearate or ferric myristate, and phenols, such as tannic acid, gallic acid, or ammonium salicylate.

(e) A combination of an organic acid heavy metal salt, such as nickel, cobalt, lead, copper, iron, mercury, silver salt of acetic acid, stearic acid, or palmitic acid and an alkaline metal or an alkaline earth metal sulfide, such as calcium sulfide, strontium sulfide, or potassium sulfide, or a combination of the organic acid heavy metal salt and an organic chelator, such as s-diphenylcarbarzide or diphenylcarbazone.

(f) A combination of a heavy metal sulfate, such as sulfate of silver, lead, mercury, or potassium, and a sulfur compound, such as sodium tetrathionate, sodium thiosulfate, or thiourea.

(g) A combination of an aliphatic ferric salt, such as ferric stearate, and an aromatic polyhydroxy compound, such as 3,4-hydroxytetraphenylmethane.

(h) A combination of an organic acid metal salt, such as silver oxalate or mercury oxalate, and an organic polyhydroxy compound, such as polyhydroxyalcohol, glycerin, or glycol.

(i) A combination of a fatty acid ferric salt, such as ferric pelargonate or ferric laurate, and a thiocecylcarbamide or isothiocecylcarbamide derivative.

(j) A combination of an organic acid lead salt, such as lead caproate, lead pelargonate, or lead behenate, and a thiourea derivative, such as ethylenethiourea or N-dodecylthiourea.

(k) A combination of a higher aliphatic heavy metal salt, such as ferric stearate or copper stearate, and a zinc dialkyldithiocarbamate.

(l) A combination forming an oxazine dye, such as a combination of resorcin and a nitroso compound.

(m) A combination of a formazan compound and a reducing agent and/or a metal salt.

(n) A combination of a protected dye (or leuco dye) precursor and a deprotective agent.

(o) A combination of an oxidation type color forming agent and an oxidant.

(p) A combination of phthalonitriles and diiminoisoindolines (a combination producing phthalocyanine).

(q) A combination of isocyanates and diiminoisoindolines (a combination producing a coloring pigment).

(r) A combination of a pigment precursor and an acid or base (a combination producing a pigment).

As the first component described above, preferably, the electron donating colorless dye or diazonium salt compound is substantially used.

As the electron donating colorless dye, known materials may be used. Any materials may be used as long as they react with the second component to form the colors. Specifically, various compounds, such as phthalide compounds, fluorane compounds, phenothiazine compounds, indolylphthalide compounds, leuco auramine compounds, rhodamine lactam compounds, triphenylmethane compounds, triazene compounds, spiropyrane compounds, pyridine compounds, pyrazine compounds, and fluorene compounds, may be exemplified.

As the second component, in the case of non-photochromic toner, a material that is a substantially colorless compound having both in the same molecule, a photopolymerizable group and a part which reacts with the first component to exhibit coloration, reacting with the first component, such as an electron accepting compound having a photopolymerizable group or a coupler compound having a photopolymerizable group, to form color. As long as the second component has both functions of reacting with the first compound to display coloration, reacting with light to polymerize and cure, then any material can be used.

As the electron accepting compound having the photopolymerizable group, that is, a compound having an electron accepting group and a photopolymerizable group in the same molecule, any materials may be used insofar as they have the photopolymerizable group and react with the electron donating colorless dye that is one of the first components to form color and is photopolymerized and cured.

As an electron accepting developer that is the second component in the photochromic toner, phenol derivatives, sulfurated phenol derivatives, organic carboxylic acid derivatives (for example, salicylic acid, stearic acid, or resorcinol acid), metal salts of them, sulfonic acid derivatives, urea or thiourea derivatives, acid clay, bentonite, novolak resin, metal-treated novolak resin, and metal complexes may be exemplified.

In the photochromic toner, a polymerizable compound having etylenically unsaturated bond is used as a photopolymerizable compound, which is a polymerizable compound having at least one etylenically unsaturated double bond in the molecule, such as acryl acids and salts thereof, ester acrylates, or acrylamides.

Next, the photopolymerization initiator will be described. The photopolymerization initiator may generate radicals by irradiating light for the application of the color forming information and may cause a polymerization reaction in the light curing composition to promote the reaction. The light curing composition is cured by the polymerization reaction.

The photopolymerization initiator may be appropriately selected from known materials. Of these, a photopolymerization initiator that contains a spectral sensitization compound having a maximum absorption wavelength at 300 to 1000 nm and a compound that interacts with the spectral sensitization compound are preferably included.

However, in the case that the compound interacting with the spectral sensitization compound is a compound that has both structures of a dye portion having a maximum absorption wavelength of 300 to 1000 nm and a borate portion therein, the spectral sensitization dye need not be used.

As the compound interacting the spectral sensitization compound, one kind or two or more kinds of compounds may be appropriately selected and used from known compounds that initiate the photopolymerization reaction with the photopolymerizable group in the second component.

This compound coexists with the spectral sensitization compound and sensitively responds to irradiated light of a spectral sensitization wavelength region, to thereby generate the radicals with high efficiency. Therefore, high sensitivity may be realized, and the generation of the radicals may be controlled using an arbitrary light source in an infrared to ultraviolet region.

As the “compound interacting the spectral sensitization compound”, organic borate compounds, benzoinether, S-triazine drivatives having a trihalogen-substituted methyl group, organic peroxides, azinium salt compounds are preferably used, and more preferably, organic borate compounds are used. When the “compound interacting with the spectral sensitization compound” is used together with the spectral sensitization compound, the radicals may be locally and effectively generated at an exposed portion, and high sensitivity may be achieved.

Further, in the light curing composition, a reducing agent, such as an oxygen scavenger or a chain-transfer aid of an active hydrogen donor, or other compounds may be added as an auxiliary agent to promote the polymerization reaction.

As the oxygen scavenger, phosphine, a phosphonate, a phosphite, and other compounds easy to be oxidized by an Ag(I) salt or oxygen may be exemplified. Specifically, N-phenylglycine, trimethylbarbituric acid, N,N-dimethyl-2,6-diisopropylaniline, N,N,N-2,4,6-pentamethylanilinic acid may be exemplified. Further, thiols, thioketones, trihalomethyl compounds, lophine dimer compounds, iodonium salts, sulfonium salts, azinium salts, organic peroxides, and azides are also used as a polymerization promoting agent.

In the F toner, the first component, such as the electron donating colorless dye or the diazonium salt compound, is encapsulated in the microcapsules for use.

For forming the microcapsules, any known methods may be used. Examples include a method of using coacervation of a hydrophilic wall forming material described in U.S. Pat. Nos. 2,800,457 and 2,800,458; an interfacial polymerization method described in U.S. Pat. No. 3,287,154, U.K. Patent No. 990,443, and Japanese Patent Application Publication (JP-B) Nos. 38-19574, 42-446, and 42-711; a method of polymer precipitation described in U.S. Pat. Nos. 3,418,250 and 3,660,304; a method of using an isocyanate-polyol wall forming material described in U.S. Pat. No. 3,796,669; a method of using an isocyanate wall forming material described in U.S. Pat. No. 3,914,511; a method of using a urea-formaldehyde or urea-formaldehyde-resorcinol wall forming material described in U.S. Pat. Nos. 4,001,140, 4,087,376, and 4,089,802; a method of using a melamine-formaldehyde resin or hydroxy propyl cellulose and the like as a wall forming material described in U.S. Pat. No. 4,025,445; an in-situ method by monomer polymerization described in Japanese Patent Application Publication (JP-B) No. 36-9168 and Japanese Patent Application Laid-Open (JP-A) No. 51-9079; an electrolytic dispersion and cooling method disclosed in U.K. Patent Nos. 952,807 and 965,074; a spray-drying method described in U.S. Pat. No. 3,111,407 and U.K. Patent No. 930,422; and a method described in JP-B No. 7-73069 and JP-A Nos. 4-101885 and 9-263057.

The available material of the microcapsule wall is added inside and/or outside of oil droplets. Examples of the material of the microcapsule wall preferably includes polyurethane, polyurea, polyamide, polyester, polycarbonate, a urea-formaldehyde resin, a melamine resin, polystyrene, a styrenemethacrylate copolymer, and a styrene-acrylate copolymer. Of these, polyurethane, polyurea, polyamide, polyester, and polycarbonate are preferably used, and more preferably, polyurethane and polyurea are used. Two or more of the polymer materials may be used together.

The volume-average particle diameter of the microcapsule is preferably adjusted within a range of 0.1 to 3.0 μm, and more preferably, adjusted within a range of 0.3 to 1.0 μm.

A binder may be included in the photosensitive/thermosensitive capsule. The same is applied to a toner having one color forming portion.

As the binder, the same binders as those used for emulsion dispersion of the light curing composition and water-soluble polymers used when encapsulating a first reactive material may be used. Other than the above binder materials, solvent-soluble polymers including polystyrene, polyvinylformal, polyvinylbutyral, acrylic resins, such as polymethylacrylate, polybutylacrylate, polymethylmethacrylate and polybutylmethacrylate, and copolymers of these acrylates, phenol resins, styrene-butadiene resins, ethyl cellulose, epoxy resins, and urethane resins or polymer latexes of these polymers may be used. More preferably, a gelatin and polyvinyl alcohol are used. Further, a binder resin which will be described later may be used as a binder.

Further, in the F toner, a binder resin that is used in a known toner may be used. For example, in a toner having a structure, in which the photosensitive/thermosensitive capsules are dispersed into the base material, the binder resin may be used as a main component forming the base material or a material forming the outer shell of the photosensitive/thermosensitive capsule, but not limited thereto.

The binder resin is not particularly limited, and a known crystalline or amorphous resin material may be used. In particular, in view of the application of low-temperature fixability, a crystalline polyester resin having a sharp melting property is useful. In addition, as an amorphous polymer (amorphous resin), known resin materials, such as a styrene-acrylic resin and a polyester resin, may be used. More preferably, an amorphous polyester resin is used.

In addition, the F toner may include other components than the above-described components. Though not particularly limited, components may be appropriately selected according to the purposes. For example, various known additives used in the known toner, such as a releasing agent, inorganic fine particles, organic fine particles, and a charging control agent, may be exemplified.

Moreover, the first component and the second component of the F toner of the aspect of the invention may be colored in advance before color forming, and more preferably, the components may be substantially colorless materials.

Next, a method of producing an F toner will be simply described.

The F toner is preferably produced using a known wet producing method, such as an aggregation coalescence method. In particular, the wet producing method is suitable for producing the toner including the first component and the second component that react with each other to form the color, the light curing composition, and the microcapsules that are dispersed into the light curing composition. Here, the first component is included in the microcapsules, and the second component is included in the light curing composition.

Moreover, the microcapsules used in the toner having the above-described structure are more preferably thermoresponsive microcapsules, but microcapsules that respond to other stimulus, such as light or the like, may be used.

The known wet producing method may be used to producing the toner. Of the wet producing methods, the aggregation coalescence method is more preferably used since it may be possible to suppress the highest process temperature low and it is easy to produce toners having various structures.

Further, the toner having the above-described structure includes the light curing composition, primarily containing low-molecular-weight components, more than the toner having the known pigment or a binder resin. Accordingly, although the strength of the particle obtained by a toner granulation step tends to be insufficient, a high cutting force is not required in the aggregation coalescence method. From this viewpoint, it is appropriate to use the aggregation coalescence method.

In general, the aggregation coalescence method includes after preparing various materials of dispersion liquids forming the toner: an aggregation step of forming aggregated particles in a raw material dispersion liquid in which two or more dispersion liquids are mixed; and a fusing step of fusing the aggregated particles formed in the raw material dispersion liquid. If necessary, an adhesion step (coating layer forming step), of adhering a component forming a coat layer onto the surfaces of the aggregated particles to form the coat layer, may be performed between the aggregation step and the fusing step.

In the F toner production, the kinds of various dispersion liquids used as raw materials and the combinations are different, but the toner may be produced by combining the aggregation step and the fusing step, and if necessary the adhesion step, in addition.

For example, in case of a toner having a structure in which photosensitive/thermosensitive capsules are dispersed into a resin, first, through (a1) a first aggregation step of forming first aggregated particles in a raw material dispersion liquid including a microcapsule dispersion liquid having dispersed therein the microcapsules including the first component and a light curing composition dispersion liquid having dispersed therein the light curing composition including the second component, (b1) an adhesion step of adding a first resin particle dispersion liquid having dispersed therein resin particles to the raw material dispersion liquid having formed therein the first aggregated particles and adhering the resin particles to the surfaces of the aggregated particles, and (c1) a first fusing step of heating and amalgamating the raw material dispersion liquid including the aggregated particles having the resin particles to their surfaces and obtaining first amalgamated particles (photosensitive/thermosensitive capsules), one or more kinds of photosensitive/thermosensitive capsule dispersion liquids that may form different colors are prepared.

Subsequently, through (d1) a second aggregation step of forming second aggregated particles in a mixture solution obtained by mixing one or more kinds of photosensitive/thermosensitive capsule dispersion liquids and the second resin particle dispersion liquid having dispersed therein the resin particles, and (e1) a second fusing step of heating the mixture solution including the second aggregated particles and obtaining second amalgamated particles, a toner having a photosensitive/thermosensitive capsule dispersion structure may be obtained.

Moreover, two or more kinds of photosensitive/thermosensitive capsule dispersion liquids are preferably used in the second aggregation step. Further, the photosensitive/thermosensitive capsules obtained through the steps (a1) to (c1) may be used as a toner (that is, a toner including only one color forming portion).

Further, when producing the toner including only one color forming portion, instead of the above-described adhesion step, a first adhesion step of adding a releasing agent dispersion liquid having dispersed a releasing agent to the raw material dispersion liquid having formed therein the first aggregated particles and adhering the releasing agent to the surfaces of the aggregated particles, and a second adhesion step of adding the first resin particle dispersion liquid having dispersed therein the resin particles to the raw material dispersion liquid and adhering the resin particles to the surfaces of the aggregated particles having adhered thereto the releasing agent may be performed.

The volume-average particle diameter of the F toner that may be used in the aspect of the invention is not particularly limited, but may be appropriately adjusted according to the structure, the kinds, or the number of the color forming portions included in the toner.

However, when approximately two to four kinds of color forming portions that may form different colors are included in the toner (for example, three kinds of color forming portions that respectively form yellow, magenta, and cyan are included in the toner), the volume-average particle diameter according to each toner structure is preferably within the following range.

For example, when the toner structure is a structure in which the photosensitive/thermosensitive capsules (color forming portions) are dispersed in the resin, the volume-average particle diameter of the toner is preferably within a range of 5 to 40 μm, and more preferably, within a range of 10 to 20 μm. Further, the volume-average particle diameter of each of the photosensitive/thermosensitive capsules included in the toner having photosensitive/thermosensitive capsule dispersion structure having such a particle diameter is preferably within a range of 1 to 5 μm, and more preferably, within a range of 1 to 3 μm.

When the volume-average particle diameter of the toner is less than 5 μm, the amount of the color forming components included in the toner is made smaller, and thus color reproducibilty may deteriorate and an image density may be lowered. Further, when the volume-average particle diameter exceeds 40 μm, unevenness of an image surface may become large, irregularity in gloss of the image surface may occur, and image quality may be lowered.

Moreover, the toner having the photosensitive/thermosensitive capsule dispersion structure having dispersed therein a plural photosensitive/thermosensitive capsules tends to have a larger particle diameter compared with the toner having a small diameter using the known colorant (the volume-average particle diameter of about 5 to 10 μm). However, since resolution of an image is determined by the particle diameter of the photosensitive/thermosensitive capsule, not the particle diameter of the toner, it may be possible to obtain a higher definition image. In addition, since excellent fine particle fluidity is obtained, it may be possible to secure sufficient fluidity even though the amount of the external additive is small, and to improve development and cleaning properties.

Meanwhile, in case of the toner having only one color forming portion, the small diameter is more easily realized compared with the above-described case. The volume-average particle diameter is preferably within a range of 3 to 8 μm, and more preferably, within a range of 4 to 7 μm. When the volume-average particle diameter is less than 3 μm, since the particle diameter is excessively small, sufficient fine particle fluidity may not obtained and sufficient durability may be not obtained. Further, when the volume-average particle diameter exceeds 8 μm, a high definition image may be not obtained.

In the aspect of the invention, starting with the above-described F toner, any toner may be used, regardless of the used forming materials, the structure of the toner, and the color forming mechanism, insofar as it is controlled to be kept in the color forming or non-color forming state when light is irradiated (or light is not irradiated).

In the toner that may be used in the aspect of the invention, preferably, a volume-average particle diameter distribution index GSDv is 1.30 or less, and a ratio (GSDv/GSDp) between the volume-average particle diameter distribution index GSDv and a number-average particle diameter distribution index GSDp is 0.95 or more.

More preferably, the volume-average particle diameter distribution index GSDv is 1.25 or less, and the ratio (GSDv/GSDp) between the volume-average particle diameter distribution index GSDv and the number-average particle diameter distribution index GSDp is 0.97 or more.

When the volume-average particle diameter distribution index exceeds 1.30, resolution of the image may be lowered. Further, when the ratio (GSDv/GSDp) between the volume-average particle diameter distribution index GSDv and the number-average particle diameter distribution index GSDp is less than 0.95, chargeability of the toner may be lowered, the toner may be shattered, or flogging may occur, which results in defective images.

Moreover, in the aspect of the invention, the value of the volume-average particle diameter of the toner or the values of the above-described volume-average particle diameter distribution index GSDv and number-average particle diameter distribution index GSDp are measured and calculated in the following manner.

First, a cumulative distribution curve is drawn from the smaller side using the volume and the number of toner particles classified according to particle size ranges (channel) divided based on the toner particle size distribution measured by an analyzer, such as Coulter Multisizer II (manufactured by Beckmann Coulter Inc.). Then, the particle diameters at a cumulative count of 16% are defined as a volume-average particle diameter D16v and a number-average particle diameter D16p, and the particle diameters at a cumulative count of 50% are defined as the volume-average particle diameter D50v and the number-average particle diameter D50p. Similarly, the particle diameters at a cumulative count of 84% are defined as the volume-average particle diameter D84v and the number-average particle diameter D84p. At this time, the volume-average particle size distribution index GSDv is defined as (D84v/D16v)½, and the number-average particle diameter distribution index GSDp is defined as (D84p/D16p)½. With the relational expressions, it may be possible to calculate the volume-average particle diameter distribution index GSDv and the number-average particle diameter distribution index GSDp.

Further, the volume-average particle diameter of the microcapsule or the photosensitive/thermosensitive capsule may be measured, for example, using a laser diffraction particle size analyzer (LA-700 manufactured by Horiba, Ltd.).

Further, in the toner of the aspect of the invention, a shape coefficient SF1 represented by the following expression (1) is preferably within a range of 110 to 130.

SF1=(ML²/A)×(π/4)×100 Expression (1)

### [Wherein, in the expression (1), ML represents the maximum length (μm) of the toner, and A represents a projection area (μm²) of the toner.]

When the shape coefficient SF1 is less than 110, at the transfer step upon image forming, the toner is liable to remain on the image retention medium, and it is necessary to remove the remaining toner. In this case, the cleaning property is liable to be damaged upon cleaning of the remaining toner by a blade or the like. As a result, the defective images may occur.

Meanwhile, when the shape coefficient SF1 exceeds 130, if the toner is used as a developer, the toner may be destroyed by collision against carriers in the developing unit. At this time, dust particles may be increased accordingly, and thus the image retention medium is stained with the releasing agent component exposed from the toner surface. As a result, charging characteristics may be impaired, and fogging may be caused by the dust particles.

The shape coefficient SF1 is measured in the following manner using a Luzex image analyzer (FT manufactured by Nireco Corp.). First, an optical micrograph of the toner scattered on slide glass is imported to the Luzex image analyzer through a video camera, and the maximum length ML and the projection area A are measured for 50 or more toners. Then, for each toner, the second power of the maximum length and the projection area are calculated, and the shape coefficient SF1 is obtained therefrom by the expression (1).

The toner used in the aspect of the invention may be used as a one-component developer but, in the aspect of the invention, a two-component developer having a carrier and a toner is preferably used as the toner.

Here, from a viewpoint that a color image may be formed by one kind of developer, the developer is preferably (1) a developer of a type that has one kind of toner having the light curing composition and two or more kinds of color forming portions including microcapsules dispersed in the light curing composition, and the two or more kinds of color forming portions included in the toner forming different colors or (2) a developer of a type that has two or kinds of toners in a mixture state each having the light curing composition and one color forming portion including microcapsules dispersed in the light curing composition, and the color forming portions of the two or more kinds of toners formed different colors.

For example, in the developer of the former type, three kinds of color formed portions are included in the toner, and the three kinds of color forming portions preferably have a yellow color forming portion forming yellow, a magenta color forming portion forming magenta, and a cyan color forming portion forming cyan. Further, in the developer of the latter type, a yellow color forming toner having a color forming portion forming yellow, a magenta color forming toner having a color forming portion forming magenta, and a cyan color forming toner having a color forming portion forming cyan are preferably included in the developer in a mixture state.

As the carrier that may be used in the two-component developer, a resin is preferably covered on the surface of a core material. The core material of the carrier is not particularly limited insofar as it satisfies the above-described condition. For example, magnetic metals, such as iron, steel, nickel, and cobalt, alloys of the magnetic metals, and mangan, chromium, and earth metals, magnetic oxides, such as ferrite and magnetite may be exemplified. In view of the surface property and resistance of the core material, ferrite, in particular, alloys of mangan, lithium, strontium, and magnesium preferably may be exemplified.

Further, the resin covering the core material is not particularly limited insofar as it may be used as a matrix resin, and may be appropriately selected according to the purposes.

In the two-component developer, a mixture ratio (mass ratio) of the toner of the aspect of the invention and the carrier is preferably within a range of about toner: carrier=1:100 to 30:100, and more preferably, within a range of about 3:100 to 20:100.

An image forming apparatus of the aspect of the invention will now be described.

The image forming apparatus of the aspect of the invention uses the above-described F toner, and obtains color images adapting an electrophotography method.

An image forming process in the image forming apparatus of the aspect of the invention is not particularly limited, but a so-called electrophotography process, a process (ionography) of forming an electrostatic latent image by ions on a dielectric, a process of forming an electrostatic latent image according to image information by a thermal head on a uniformly charged dielectric, a process of forming a magnetic latent image so as to form a toner image, without using an electrostatic latent image, and a process of forming adhesive ink droplets on an image retention medium so as to form a toner image may be exemplified.

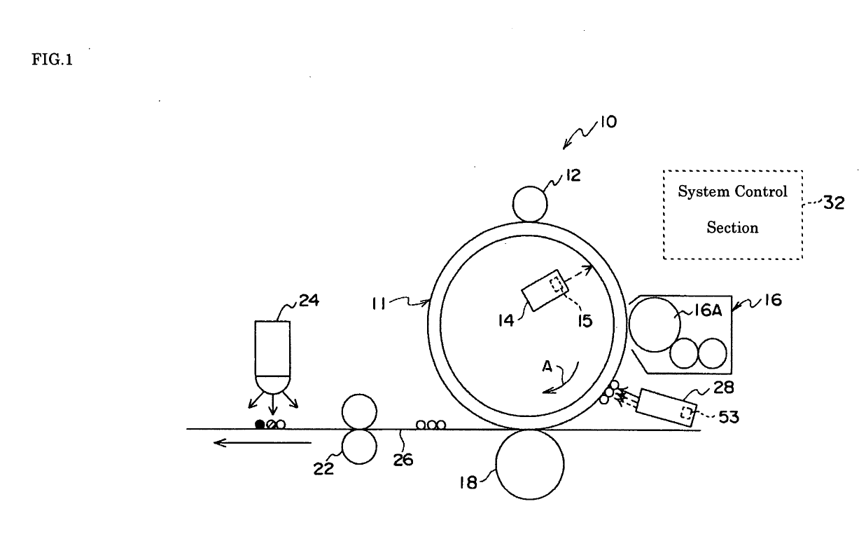

As shown in FIG. 1, the image forming apparatus 10 of the aspect of the invention includes a photoreceptor (image retention medium) 11 to be used in a normal electrophotography process. The photoreceptor 11 is provided to rotate in a predetermined direction (a direction of an arrow A in FIG. 1). An exposure device (exposure unit) 14 is provided on the inner peripheral surface of the photoreceptor 11. Further, a charging device (charging unit) 12, a developing device (developing unit) 16, a color forming information application device 28, and a transfer device (transfer unit) 18 are provided close to the outer peripheral surface of the photoreceptor 11 in accordance with the rotation direction of the photoreceptor 11.

As the photoreceptor 11, known photoreceptor may be used. For example, an inorganic photosensitive layer formed of Se or a-Si, or a single-layer or multilayer of organic photosensitive layer formed on a conductive base substance. In case of a belt-shaped receptor, a transparent resin, such as PET or PC, may be used as the base substance, and the thickness thereof is determined from design conditions, such as a diameter of roll tensioning the belt-shaped photoreceptor and the tension, and is approximately within a range of about 10 to 500 μm. Other layer formations and the like are the same as those of the drum.

Moreover, when exposure by the color forming information by the color forming information application device 28 to be described below is performed from the rear surface of the photoreceptor 11 (the inside of the photoreceptor), a transparent photoreceptor in which the base substance is formed of a transparent resin may be used. In case of the transparent photoreceptor, a material transparent to the exposure light is used as the base substance of the photoreceptor.

Here, “transparent” means having transmittance for allowing sufficient energy to be applied such that energy of incident light passes through the material of the base substance and acts on the photosensitive layer or the toner. For example, when an output of 0.1 mW to the photosensitive layer is required, if the light incident on the base substance is light of 0.3 mW, and transmittance of 33% is obtained, then in the present image forming apparatus, this is regarded as “transparent”.

The transparent photoreceptor 11 has the substrate formed of a transparent material, such as glass, plastic, or the like, and the photosensitive layer and the like are provided on the surface of the base substance. The thickness of the substrate is determined from required mechanical strength, and is preferably within a range of about 0.1 to 5 mm. A transparent electrode is preferably provided on the transparent base substance. As the transparent electrode, one in which fine particles of a metal oxide, such as ITO or SnO₂, are mixed in a binder resin, or one having coated thereon a conductive polymer, such as polypyrrole, may be used. The thickness of the transparent electrode is determined from required conductivity and permeability, and is preferably within a range of about 0.01 to 10 μm.

As the photosensitive layer, for example, an inorganic photosensitive layer formed of Se or a-Si, or a single-layer or multilayer (charge generating layer, charge transporting layer, and the like) organic photosensitive layer may be exemplified. Further, in order to cause to more scattering of the incident light, metal oxide and organic particles, such as fluorine resin, having a particle diameter of tens of nanometers to several microns are preferably dispersed in the photosensitive layer.

However, as described above, since light is required to pass through the photosensitive layer such that the toner is also exposed to light, as the standard of permeability, transmittance by the photosensitive layer is preferably 50% or more, and more preferably, 70% or more.

Further, the exposure for the application of the color forming information is performed at higher intensity than the exposure for normal latent image formation. Specifically, the energy amount of light for the application of the color forming information needs to be about 1000 times as much as the light amount of the photoreceptor used in the normal electrophotography process (2 mJ/m²). For this reason, there is a concern that damage of the photosensitive layer 11 by the application of the color forming information might occur, but, when photosensitivity of the charge generating layer of the photoreceptor 11 is 1/1000 th of that conventionaly used, a balance can be arrived at, and problems are avoided.

Moreover, the thickness of the photosensitive layer is determined from the insulation propertyresistance to charging potential, in consideration of permeability and time-variant film shrinkage, and is preferably within a range of 5 to 50 μm.

In case of the belt-shaped photoreceptor, a transparent resin, such as PET or PC, may be used as a transparent base substance, and the thickness thereof is determined from design conditions such as the diameter of rolls tensioning the belt-shaped receptor and tension. Preferably, the thickness is approximately within a range of 10 to 500 μm. Other layer formations and so on are the same as those of the drum.

Meanwhile, when the toner image is formed by ionography, a dielectric is used instead of the photoreceptor 11. A transparent dielectric is preferably used as the dielectric for the same reason.

As the transparent dielectric, a transparent dielectric layer, that is, a layer formed of transparent plastic, such as PET or PC, may be used, instead of the photosensitive layer in the transparent photoreceptor.

The charging device 12 charges the outer peripheral surface of the photoreceptor 11 at a predetermined potential.

As the charging device 12 charging the photoreceptor 11, a known charging device may be used. In case of a contact type, a roll, a brush, a magnetic brush, or a blade may be used. In case of a non-contact type, corotron or scorotron may be used. The charging device 12 is not limited to them.

Of these, from the balance of charging compensation capability and an ozone generation amount, the contact-type charger is preferably used. The contact-type charging method charges the surface of the photoreceptor 11 by applying a voltage to a conductive member that comes into contact with the surface of the photoreceptor 11. That is, in this case, though not shown, the charging device 12 may include a voltage applying unit that applies a voltage to the conductive member.

The shape of the conductive member may be any one of a brush shape, a blade shape, a pin electrode shape, and a roll shape, but more preferably, a roll-shaped member is used. Normally, the roll-shaped member has, from the outside, a resistive layer, and an elastic layer and a core member supporting the resistive layer. If necessary, a protective layer may be provided outside the resistive layer.

As a method of charging the photoreceptor 11 using the conductive member, a voltage is applied to the conductive member by the voltage applying unit, and the applied voltage is preferably a direct current voltage or a direct current voltage on which an alternating current voltage is superimposed. When charging is performed only by a current, as the range of the voltage is preferably positive or negative of about a desired surface potential +500 V as an absolute value. This value is in a range of 700 to 1500 V. When the alternating current voltage is superimposed, the value of the direct current is set to about the desired surface potential ±50 V, an inter-peak voltage Vpp of the alternating current is in a range of 400 to 1800 V and preferably, in a range of 800 to 1600 V, and a frequency of the alternating current voltage is in a range of 50 to 20000 Hz and preferably, in a range of 100 to 5000 Hz. A sine wave, a square wave, or a triangular wave may be used.

The charging potential is preferably set in a range of 150 to 700 V as an absolute value.

The exposure device 14 is provided on the inner peripheral surface of the photoreceptor 11. The exposure device 14 includes an exposure light source 15 serving as a first light source that emits light in a direction from the inner peripheral surface of the photoreceptor 11 toward the outer peripheral surface. In the exposure device 14, light that is modulated on the basis of image data of an image to be recorded in the image forming apparatus 10 is emitted from the exposure light source 15. Exposure is made by light emitted from the light source 15 from the inner peripheral surface of the photoreceptor 11 toward the outer peripheral surface. Then, an electrostatic latent image is formed on the outer peripheral surface of the photoreceptor 11 charged by the charging device 12 according to the image data.

As the exposure device 14 that forms the electrostatic latent image on the photoreceptor 11, a known exposure device may be used. For example, a laser scanning system, an LED image bar system, and an ion stream control head may be used. As well as the above-described systems, a new exposure unit to be developed in future may be used as long as it can achieve the effects of the aspect of the invention.

The wavelength of the exposure light source 15 that emits light in the direction from the inner peripheral surface of the photoreceptor 11 toward the outer peripheral surface so as to expose the outer peripheral surface of the photoreceptor 11 is in the spectral sensitization region of the photoreceptor 11. Until now, a near-infrared ray having an oscillation wavelength of about 780 nm as the wavelength of a semiconductor laser is mainly used, but a laser having an oscillation wavelength of the order of about 600 nm or a blue laser having an oscillation wavelength of about 400 to 450 nm may be used. Further, for the color image formation, a surface emission-type laser light source outputting multi beams is effective. Further, an LED (Light Emitting Diode) may be used.

Moreover, for a reduction in size of the image forming apparatus 10, the LED is preferably used as the exposure light source 15.

The wavelength of light emitted from the exposure light source 15 is preferably different from the wavelength of light emitted from a light source 53 of the color forming information application device 28 described below. As such, since the wavelength of light emitted from the exposure light source 15 and the wavelength of light emitted from the light source 53 are different from each other, it may be possible to make the wavelength region to which the photosensitive layer has sensitivity and the wavelength of light emitted from the second light source different from each other. Accordingly, it may be possible to suppress deterioration of the photosensitive layer by light from the second light source.

Exposure to the photoreceptor 11 is performed, for example, as a logical sum of image information of three colors (YMC) at a position where a toner described below is developed, in case of inversion development, and at other positions than the position where the toner is developed, in case of normal development.

As for an exposure spot diameter, a diameter, 1/e² of peak intensity in an intensity profile, is preferably in a range of 30 to 100 μm such that the resolution is in a range of 300 to 2400 dpi. The exposure is preferably set such that a potential of the exposed region on the photoreceptor 11 (hereinafter, appropriately referred to as a post-exposure potential) is in a range of about 5 to 30% of the charging potential. In this embodiment, in order to change the development amount of the toner according to the image density, the exposure is changed according to the density (gray-scale value) for each exposure position.

Meanwhile, in case of ionography, the latent image is formed on the image retention medium by an ion writing head. As the ion writing head, one that performs an On/Off control of the ion stream by an image signal (JP-A No. 4-122654) or one that performs an On/Off control of the generation of the ion stream (JP-A No. 6-99610) may be used.

Moreover, according to this method, the photoreceptor as well as the dielectric may be used as the image retention medium.

The developing device 16 develops the electrostatic latent image formed on the outer peripheral surface of the photoreceptor 11. That is, the developing device 16 forms the toner image according to the electrostatic latent image on the photoreceptor 11.

The developing device 16 stores the above-described F toner. The developing device 16 includes a developing roll 16A that holds the toner stored in the developing device 16 and supplies the toner to the surface of the photoreceptor 11.

As the developing device 16, a known developing device 16 may be used. As a developing method, a two-component developing method using fine and small particles for holding the toner referred to as carriers and the toner, or a one-component developing method using only the toner may be used. Further, in these developing methods, when an additional material is used for the improvement of other characteristics than the development, all the above developing methods may be used.

Further, according to the developing methods, the developer is in or out of contact with the photoreceptor so as to perform the development. Also, any combination thereof may be used. In addition, a hybrid developing method, which is a combination of the one-component developing method and the two-component developing method may be used. Besides, a new developing unit to be developed in future may be used insofar as it can achieve the effects of the aspect of the invention.

Moreover, as the toner included in the developer, for example, one having a color forming portion (Y color forming portion) forming yellow, a color forming portion (M color forming portion) forming magenta, and a color forming portion (C color forming portion) forming cyan included in one toner particle may be used. Further, the Y color forming portion, the M color forming portion, and the C color forming portion may be included in the individual toners.

Further, in the formed toner image, since light for the application of the color forming information described below needs to be widespread in the entire irradiated portion, the toner layer thickness is preferably limited to be less than a predetermined value. Specifically, for example, the toner layer in a solid image has preferably three or less layers, and more preferably, two or less layers. Moreover, the toner layer thickness is a value obtained by measuring the thickness of the toner layer actually formed on the surface of the photoreceptor 11 and dividing the measured thickness by the number-average particle diameter.

The color forming information application device 28 has the light source 53 that emits light having a prescribed wavelength corresponding to a color to be formed or a color to be not formed on the basis of color component information in image data. The color forming information application device 28 irradiates light emitted from the light source 53 onto the individual toners forming the toner image formed on the photoreceptor 11 from the outer peripheral surface of the photoreceptor 11 so as to apply the color forming information to the individual toners forming the toner image.

Moreover, in FIG. 1, a case where the color forming information application device 28 is provided between the developing unit 16 and the transfer unit 18 that is provided on the downstream side of the developing unit 16 in the rotation direction of the photoreceptor 11 has been described, but the color forming information application device 28 may be provided on the downstream side in a transport direction of a recording medium 26 from the transfer device 18, such that the toner transferred to the recording medium 26 is exposed to light.

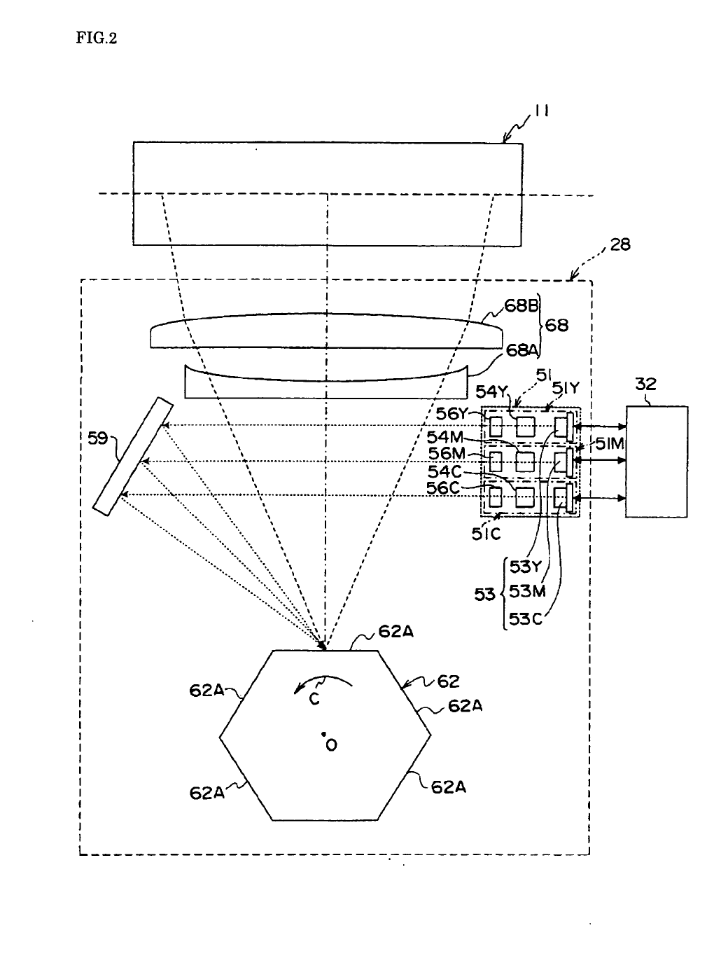

As shown in FIG. 2, the color forming information application device 28 scans and exposes light from the outer peripheral surface of the photoreceptor 11 in a direction along the rotational shaft direction of the photoreceptor 11.

The color forming information application device 28 includes a light irradiating section 51 that has the light source 53 emitting light having a specified wavelength, a reflecting mirror 59 that reflects light emitted from the light source 53, a rotational multifaceted mirror 62 that reflects light reflected by the reflecting mirror 59 and irradiates light onto the photoreceptor 11, and an fθ lens 68.

The light irradiating section 51 has light irradiating sections corresponding to the kinds of color forming portions included in the toner, which is stored in the developing device 16. In the present embodiment, three kinds of color forming portions corresponding to YMC are included. For this reason, the light irradiating section 51 includes a Y light irradiating section 51Y corresponding to the Y color forming portion, a M light irradiating section 51M corresponding to the M color forming portion, and a C light irradiating section 51C corresponding to the C color forming portion. However, the aspect of the invention is not limited to the present embodiment.

The Y light irradiating section 51Y has a light source 53Y. The light source 53Y emits light having a prescribed wavelength corresponding to yellow as a color to be formed or yellow as a color to be not formed on the basis of the color component information representing yellow in the image data. As for the wavelength of light emitted from the light source 53Y, light having a wavelength according to the kind of a light curing composition of the Y color forming portion is prescribed. In addition, Y light irradiating section 51Y further has a collimator lens 54Y and a cylinder lens 56Y arranged in a traveling direction of light emitted from the light source 53Y. The light source 53Y is turned on/off on the basis of the color component information representing yellow in the image data under the control of a system control section 32, such that light modulated on the basis of the image data is emitted. Light emitted from the light source 53Y is approximately paralleled by the collimator lens 54Y, then is focused on by the cylinder lens 56Y, and is subsequently incident on the rotational multifaceted mirror 62 through the reflecting mirror 59.

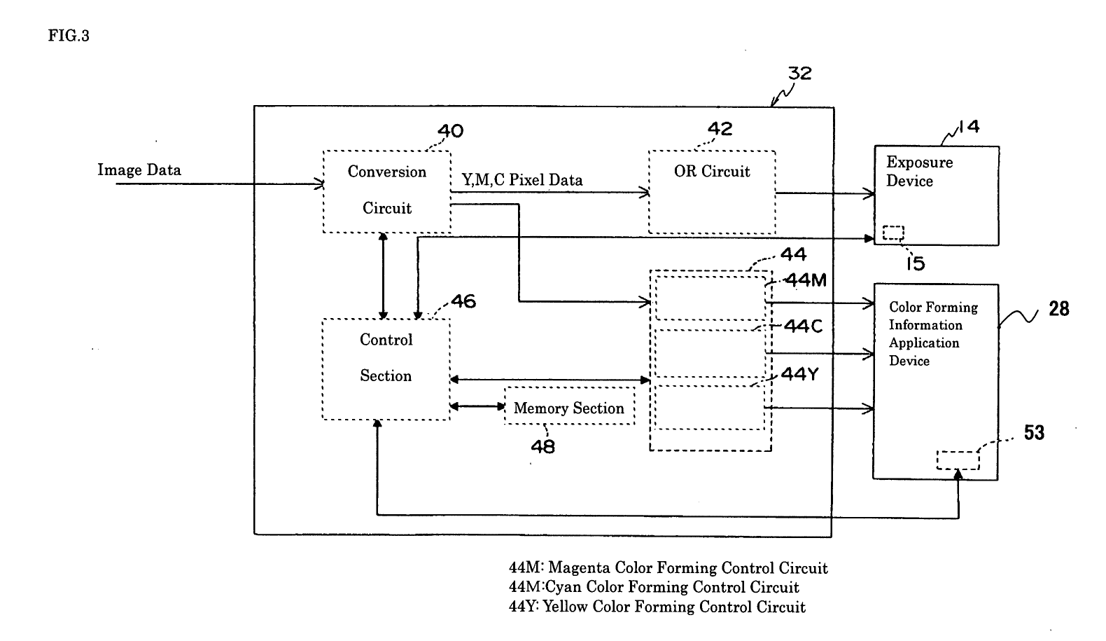

Moreover, it is assumed that, as for the toner used in the image forming apparatus 10, reference exposure information as a reference exposure of the toner to be stored in the developing device 16 is stored in a memory section 48 (see FIG. 3) (described below in detail) in advance for each color forming portion. Then, the exposure of light emitted from the light source 53Y is prescribed on the basis of the reference exposure information for each color forming portion.

Similarly, the M light irradiating section 51M has a light source 53M. The M light source emits light having a prescribed wavelength corresponding to magenta as a color to be formed or magenta as a color to be formed on the basis of the color component information representing magenta in the image data. As for the wavelength of light emitted from the light source 53M, light having a wavelength according to the kind of a light curing composition of the M color forming portion is prescribed.

In addition, the M light irradiating section 51M further has a collimator lens 54M and a cylinder lens 56M arranged in a traveling direction of light emitted from the light source 53M. The light source 53M is turned on/off on the basis of the color component information representing magenta included in the image data under the control of the system control section 32, such that a light beam modulated on the basis of the image data is emitted. The exposure of light emitted from the light source 53M is prescribed on the basis of the reference exposure information for each color forming portion.

Light emitted from the light source 53M is approximately paralleled by the collimator lens 54M, then is focused on by the cylinder lens 56M, and is subsequently incident on the rotational multifaceted mirror 62 through the reflecting mirror 59.

Similarly, the C light irradiating section 51C has a light source 53C. The C light source emits light having a wavelength determined according to the kind of a light curing composition of cyan as a color to be formed or cyan as a color to be formed on the basis of the color component information representing cyan in the image data. The exposure of light emitted from the light source 53C is prescribed on the basis of the reference exposure information for each color forming portion.

In addition, the C light irradiating section 51C further has a collimator lens 54C and a cylinder lens 56C arranged in a traveling direction of light emitted from the light source 53C. The light source 53C is turned on/off on the basis of the image data under the control of the system control section 32, such that a light beam modulated on the basis of the color component information representing cyan included in the image data is emitted. Light emitted from the light source 53C is approximately paralleled by the collimator lens 54C, then is focused on by the cylinder lens 56C, and is subsequently incident on the rotational multifaceted mirror 62 through the reflecting mirror 59.

Moreover, in the following description, the light source 53Y, the light source 53M, and the light source 53C may be collectively referred to as the light source 53.

The rotational multifaceted mirror 62 is formed in a regular polygon shape (in the present embodiment, a regular hexagon shape) having a plural reflecting surfaces 62A on side surfaces thereof. The rotational multifaceted mirror 62 rotates at a predetermined speed in a direction of an arrow C around a rotational shaft O by driving of a motor (not shown).

Light that is incident on the rotational multifaceted mirror 62 is focused by the reflecting surfaces 62A of the rotational multifaceted mirror 62 to be incident thereon. Then, an incident angle of light to each of the reflecting surfaces 62A is continuously changed by the rotation of the rotational multifaceted mirror 62. Accordingly, the light beam is scanned in an axial direction of the photoreceptor 11 to be then exposed onto the photoreceptor 11.

In the traveling direction of light reflected by the rotational multifaceted mirror 62, the fθ lens 68 having a first lens 68A and a second lens 68B is provided as a scanning lens system. The light beam reflected by the rotational multifaceted mirror 62 transmits the fθ lens 68 to be focused in a main scanning direction of the photoreceptor 11. Then, the light beam is focused in a sub scanning direction by the cylinder lens (not shown), such that an image formation point is formed on the photoreceptor 11.

The light source 53Y, the light source 53M, and the light source 53C are not particularly limited. Any light source may be used insofar as it can irradiate light having a wavelength for keeping a toner particle positioned in a region on the toner image, in which a color is to be formed, in a color formable state or a non-color formable state to a specified color with predetermined resolution and intensity.

However, since the exposure of the toner by light emitted from the light source 53, that is, the exposure for the application of the color forming information is the polymerization reaction by the photopolymerizable compound, the exposure for the application of the color forming information needs to be performed at higher intensity than the exposure for formation of the electrostatic latent image by the exposure device 14. Specifically, the energy amount of light for the application of the color forming information needs to be about 1000 times the exposure (2 mJ/m²) of the photoreceptor used in the normal electrophotography process. For this reason, as the light source 53, a light source that can perform the exposure at higher intensity than the exposure for the formation of the electrostatic latent image needs to be used.

For example, the exposure of light required for the application of the color forming information to the toner is preferably in a range of 0.05 to 0.4 mJ/cm², and more preferably, in a range of 0.1 to 0.2 mJ/cm². In particular, as for the exposure, a required exposure has relation to the amount of the developed toner. For example, the exposure is preferably performed in a range of 0.2 to 0.4 mJ/m² with respect to the toner development amount (solid) of about 5.5 g/m².

As the light source 53Y, the light source 53M, and the light source 53C that can realize the exposure, for example, an LED image bar, a laser scanning device, or the like may be used. In view of high-output exposure, a laser is preferably used. Moreover, the irradiation spot diameter of light irradiated onto the toner image of the photoreceptor 11 is preferably adjusted in a range of 30 to 100 μm such that resolution of an image to be formed is in a range of 300 to 2400 dpi, and more preferably in a range of 30 to 60 μm.

As described above, the wavelength of light for the application of the color forming information to the F toner is determined by material design of the toner to be used. For example, in case that the F toner is a photochromic toner, when yellow (Y) is to be formed, the Y light irradiating section 51Y is turned on so as to irradiate light of a wavelength of 405 nm (hereinafter, referred to as λA light) onto a position of the toner image on the photoreceptor 11, at which yellow is formed corresponding to the image data. When magenta (M) is to be formed, the M light irradiating section 51M is turned on so as to irradiate light of a wavelength of 535 nm (hereinafter, referred to as λB light) onto a position of the toner image on the photoreceptor 11, at which magenta is formed corresponding to the image data. When cyan (C) is to be formed, the C light irradiating section 51C is turned on so as to irradiate light of a wavelength of 657 nm (hereinafter, referred to as λC light) onto a position of the toner image on the photoreceptor 11, at which cyan is formed corresponding to the image data.

Further, when a secondary color is to be formed, the light components are combined, and the Y light irradiating section 51Y, the M light irradiating section 51M, and the C light irradiating section 51C are individually adjusted to be turned on or off. When red (R) is to be formed, λA light and λB light are exposed at a desired position where the corresponding color is formed. When green (G) is to be formed, λA light and λC light are exposed at a desired position where the corresponding color is formed. When blue (B) is to be formed, λB light and λC light are exposed at a desired position where the corresponding color is formed. In addition, when black (K) as a tertiary color is to be formed, λA light, λB light, and λC light are exposed together onto a desired position where the corresponding color is formed.

Meanwhile, in case of the nonphotochromic toner, for example, when yellow (Y) is to be not formed, light having a wavelength of 405 nm (λA light) is irradiated onto a desired position where the corresponding color is formed. When magenta (M) is to be not formed, light having a wavelength of 535 nm (λB light) is irradiated onto a desired position where the corresponding color is to be not formed. When cyan (C) is to be not formed, light having a wavelength of 657 nm (λC light) is irradiated onto a desired position where the corresponding color is to be not formed. Accordingly, when yellow (Y) is to be formed, λB light and λC light are irradiated onto a desired position where the corresponding color is formed. When magenta (M) is to be formed, λA light and λC light are irradiated onto a desired position where the corresponding color is formed. When cyan (C) is to be formed, λA light and λB light are irradiated onto a desired position where the corresponding color is formed.

Further, when the secondary color is to be formed, the light components are combined. That is, when red (R) is to be formed, λC light is irradiated onto a desired position where the corresponding color is formed. When green (G) is to be formed, λB light is irradiated onto a desired position where the corresponding color is formed. When blue (B) is to be formed, λA light is irradiated onto a desired position where the corresponding color is formed. In addition, when black (K) as the tertiary color is to be formed, any light component is not irradiated onto a desired position where the corresponding color is formed.

Light from the color forming information application device 28 may be modulated using a known image modulation method, such as a pulse width modulation, an intensity modulation, and a combination of them.

As described, the color forming information application device 28 in the aspect of the invention has been described by way of a mechanism when a full color image is formed, but a process of applying the color forming information by the color forming information application device 28 in the aspect of the invention may be a process of forming a monocolor image forming any one of yellow, magenta, and cyan. In this case, only light having a specified wavelength corresponding to a desired color to be formed of yellow, magenta, and cyan is irradiated from the color forming information application device 28. Other preferred conditions are the same as those in the full color image formation.

In the image forming apparatus 10 shown in FIG. 1, the application of the color forming information is performed after the development of the electrostatic latent image is performed by the developing device 16 and before the toner image is transferred to the recording medium 26, but may be performed at least before the toner image transferred to the recording medium 26 is fixed. For example, the application of the color forming information may be performed on the toner image transferred to the recording medium 26.

However, when the application of the color forming information is performed on the toner image transferred to the recording medium 26, smoothness of the surface of the recording medium 26 or accuracy of color forming position precision of a desired image is brought up. Accordingly, the application of the color forming information is preferably performed after the development of the electrostatic latent image is performed by the developing device 16 and before the toner image is transferred to the recording medium 26.

Moreover, the toner image immediately after the color forming information is applied is in a non-color formed state to have an original color tone. For example, when a sensitization dye is included, the toner image merely has the tone of the dye.

The transfer device 18 transfers the toner image on the photoreceptor 11 to the recording medium 26.

As the transfer device 18, a known transfer device may be used. For example, in case of the contact type, a roll, a brush, or a blade may be used. In case of the non-contact type, corotron, scrotron, or pin corotron may be used. In addition, the transfer by pressure or pressure and heat may be performed.

A transfer bias is preferably in a range of 300 to 1000 V (absolute value). In addition, an alternating current Vpp (400 V to 4 kV, 400 to 3 kHz) may be superimposed on the transfer bias.

The recording medium 26 accommodated in a recording medium supply portion (not shown) reaches a position to be caught between the photoreceptor 11 and the transfer device 18 and is then fed by the photoreceptor 11 and the transfer device 18. Then, the toner image on the photoreceptor 11 is transferred to the recording medium 26.

A fixing device 22 fixes the toner image transferred to the recording medium 26 onto the recording medium 26.

Moreover, the fixing device 22 also serves as a color forming device (color forming unit) that causes the toner image to form colors. In addition, a light irradiation device 24 described below may serve as the color forming device.

With the application of the color forming information, the toner image having the toner in the color formable state (or the non-color formable state) forms the colors with the application of heat from the fixing device 22.

As the fixing device 22, a known fixing unit may be used. For example, a roll and a belt as a heating member and a pressing member may be respectively selected. As a heat source, a halogen lamp, an IH, or the like may be used. The arrangement thereof may cope with various paper paths, for example, a straight path, a rear C path, a front C path, an S path, a side C path, and the like.

In the present embodiment, the fixing device 22 performs color forming of the toner image transferred onto the recording medium 26 and fixing of the toner image onto the recording medium 26, but color forming and fixing may be separately performed.

In this case, a color forming device that causes the individual toners constituting the toner image transferred onto the recording medium 26 to form colors may be separately provided.

A position of the color forming device is not particularly limited, but may be provided at a position, at which the toner image can form the colors before the toner image is fixed to the recording medium 26 by the fixing device 22.

As such, color forming of the toner image transferred to the recording medium 26 and fixing of the toner image to the recording medium 26 are performed by separate devices, and thus it may be possible to separately control a heating temperature for color forming and a heating temperature of toner fixing to the recording medium 26. Therefore, it may be possible to improve a degree of freedom for design of color forming materials, toner binder materials, and the like.

In this case, as color forming methods, various methods are considered according to color forming mechanisms of the toner particles. As the color forming devices, for example, a light emitting device that cures a color formation causing material in the toner using light having a wavelength outside the specified wavelength region or irradiates light having a specified wavelength for color forming by a method, such as photodecomposition, or a pressing device that presses and destroys the capsulized color forming particles may be used to cause the F toner to form the colors.

However, as for a chemical reaction generated in the F toner when the F toner applied with the color forming information is caused to form the colors, a response speed by migration and diffusion is generally late, sufficient energy needs to be applied in any methods. Accordingly, for the color formation of the F toner, a method of promoting the color forming reaction by heating is most effective. For this reason, it is preferable for the fixing device 22 to perform color forming of the toner image transferred onto the recording medium 26 and fixing of the toner image to the recording medium 26 even in view of space saving.

The light irradiation device 24 stabilizes color forming of the toner fixed onto the recording medium 26.

The light irradiation device 24 may decompose or deactivate the reactive material remaining in the color forming portion controlled in the non-color formable state. Accordingly, it may be possible to reliably suppress a variation in color balance after the image formation and to remove or bleach a background color.

Moreover, in the present embodiment, the light irradiation is performed after the toner image is fixed onto the recording medium 26 but, when a fixing method with no heating and melting, for example, a pressure fixing method using a pressure is used as a fixing method, the light irradiation may be performed by the light irradiation device 24 before the toner image is fixed onto the recording medium 26.

As the light irradiation device 24, any device may be used insofar as it can irradiate light capable of suppressing the progress of color forming of the toner. For example, a known lamp, for example, a fluorescent lamp, an LED, and an EL, may be used.

The wavelength of the light irradiation device 24 includes three wavelengths in light for causing the F toner to form the colors. Illuminance is preferably in a range of about 2000 to 200000 lux, and an exposure time is preferably in a range of 0.5 to 60 sec.

Moreover, in the present embodiment, the image forming apparatus 10 transfers the toner image formed on the photoreceptor 11 to the recording medium 26. However, the image forming apparatus 10 may transfer the toner image formed on the photoreceptor 11 to an intermediate transfer member, such as an intermediate transfer belt, and then transfer the toner image transferred onto the intermediate transfer member to the recording medium 26.

As described above, in the image forming apparatus 10 of the aspect of the invention, since the color forming information is applied to the individual toners forming the toner image by the color forming information application device 28, while the fixing device 22 cause the toners to form the colors, the color forming information applied to the toners are stably held. Accordingly, it is unnecessary to consider a time from the application of the color forming information until the colors are formed, and it may be possible to cope with design of a wide speed range.

Specifically, a linear speed is preferably in a range of 10 to 500 mm/sec, and more preferably, in a range of 50 to 300 mm/sec. However, even when the image formation is performed at the above-described linear speed, the exposure time for the application of the color forming information may be set to a value determined from the linear speed and resolution.

Stable holding of the color forming information by the toners has excellent effects on tone stability in the image or reproducibility of a highlight image, which contributes in forming a full color image such that input image information may be truly reproduced with high image quality.

In addition, the image forming apparatus 10 includes the system control section 32 that controls the entire image forming apparatus 10. The system control section 32 is connected to the exposure device 14, the exposure light source 15 that is provided in the exposure device 14 so as to form the electrostatic latent image on the outer peripheral surface of the photoreceptor 11, the color forming information application device 28, and the light source 53 of the color forming information application device 28 so as to transmit and receive data or signals thereto and therefrom. Further, the system control section 32 is connected to various devices provided in the image forming apparatus 10 so as to transmit and receive signals thereto and therefrom.

As shown in FIG. 3, the system control section 32 includes a conversion circuit 40, an OR circuit 42, a color forming control circuit 44, a memory section 48 that stores various kinds of data, such as the reference exposure information, and a control section 46.

The conversion circuit 40, the color forming control circuit 44, and the memory section 44 are connected to the control unit 46 so as to transmit and receive data or signals thereto and therefrom.

The control section 46 controls various units included in the image forming apparatus 10.

When image data of an image that is input from an external apparatus, such as a personal computer (not shown) through an input/output unit (not shown) and is formed by the image forming apparatus 10 is RGB data, the conversion circuit 40 converts the RGB data into YMC data, and outputs the color-converted image data to an OR circuit 42 as image data (Y pixel data, M pixel data, and C pixel data) of individual pixels of the image when it is recorded in the recording medium 26.

When the image data is input to the conversion circuit 40, the OR circuit 42 calculates a logical sum of CMY for the pixels of the individual colors and outputs the logical sum to the exposure device 14. That is, logical sum data including the image data of CMY is output to the exposure device 14.

The exposure device 14 exposes the surface of the photoreceptor 11 to light on the basis of the input logical sum data.

The YMC pixel data that is output from the conversion circuit 40 to the OR circuit 42 is also output to the color forming control circuit 44. For this reason, the color component information representing color components included in the image data is input to the color forming control circuit 44.

The color forming control circuit 44 includes a magenta color forming control circuit 44M that controls color forming of magenta, a cyan color forming control circuit 44C that controls color forming of cyan, and a yellow color forming control circuit 44Y that controls color forming of yellow.

The M pixel data, the C pixel data, and the Y pixel data that are respectively input to the magenta color forming control circuit 44M, the cyan color forming control circuit 44C, and the yellow color forming control circuit 44Y are output to the color forming information application device 28 under the control of the control section 46.

In the light source 53 of the color forming information application device 28, the light source 53Y, the light source 53M, and the light source 53C are controlled so as to emit light according to the colors of the color information of the individual pixels with the input exposures under the control of the control section 46 on the basis of the image data of the individual colors and the information representing the exposures of the light source 53Y, the light source 53M, and the light source 53C.

As such, the image forming apparatus 10 of the aspect of the invention is configured to form the electrostatic latent image according to the image data on the photoreceptor 11 by the control of the control section 46 and to apply the color forming information to the individual toners forming the toner image on which the electrostatic latent image is developed.

The photoreceptor 11 provided in the image forming apparatus 10 of the aspect of the invention will now be described in detail.

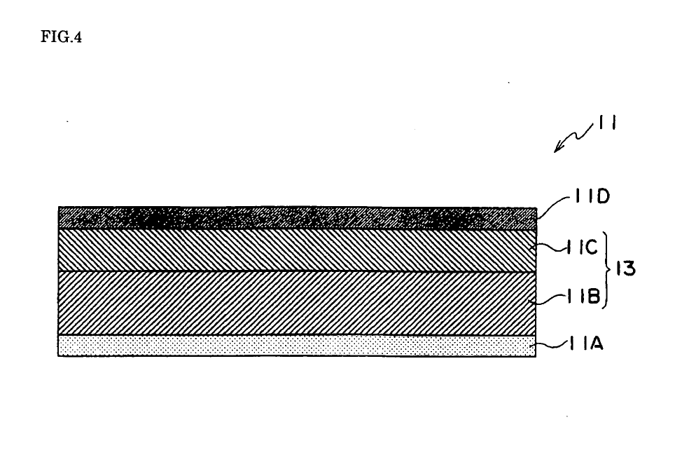

As shown in FIG. 4, the photoreceptor 11 has a conductive substrate 11A, a photosensitive layer 13, and a surface layer 11D that are sequentially laminated from the inner peripheral surface of the photoreceptor 11 toward the outer peripheral surface.

The conductive substrate 11A has permeability to light that is emitted from the exposure light source 15 (see FIG. 3) provided in the exposure device 14 and is incident on the conductive substrate 11A. The “permeability” represents transmittance of emergent light with respect to incident light (emergent light/incident light).

The transmittance of the conductive substrate 11A may be set to such an extent that the electrostatic latent image is formed on the outer peripheral surface of the photoreceptor 11 when light emitted from the exposure light source 15 of the exposure device 14 is incident from the inner peripheral surface of the photoreceptor 11 (that is, the conductive substrate 11A) toward the outer peripheral surface. The transmittance of the conductive substrate 11A is determined by the charging potential of the photoreceptor 11 by the charging device 12, the exposure of the photoreceptor 11 by the exposure light source 15, and the like.

For example, on the assumption that the electrostatic latent image can be formed on the outer peripheral surface of the photoreceptor 11 under the conditions that the exposure of light by the exposure light source 15 is a predetermined exposure and the transmittance of the conductive substrate 11A to light is 90%, when the predetermined exposure is, for example, trebled, the transmittance of the conductive substrate 11A to light may be set to 30%.

As such, the conductive substrate 11A may have permeability to light emitted from the exposure light source 15, and the transmittance may be set to such an extent that the electrostatic latent image may be formed on the surface of the photoreceptor 11.

However, in view of suppressing a decrease in contrast of the electrostatic latent image by scattering inside the conductive substrate 11A and diffusion and reflection at a boundary of the conductive substrate 11A, the transmittance of the conductive substrate 11A to light that is emitted from the exposure light source 15 and is incident on the conductive substrate 11A is preferably at least 70% or more, and more preferably, 80% or more.

As a material forming the conductive substrate 11A having permeability to incident light from the exposure light source 15, glass or plastic materials, such as polycarbonate or polyethylene terephthalate, are used. In addition, for electrode formation, a conductive layer is formed on the outer surface thereof. Moreover, the material of the conductive substrate 11A may be subject to a conduction processing.

When the conductive layer is provided on the conductive substrate 11A, as the conductive layer, a transparent electrode is preferably provided. As the transparent electrode, one in which fine particles of a metal oxide, such as ITO or SnO₂, are mixed in a binder resin, or one having coated thereon a conductive polymer, such as polypyrrole, may be used. The thickness of the transparent electrode is determined from required conductivity and permeability, and is preferably in a range of about 0.01 to 10 μm.

The thickness of the conductive substrate 11A is determined from required mechanical strength, and is preferably in a range of about 0.1 to 5 mm.

Moreover, when the photoreceptor 11 has a belt shape, as the conductive substrate 11A, a transparent resin, such as PET, PC, or the like, which exhibits permeability described above, may be used. The thickness thereof is determined from design conditions, such as a diameter or tension of a roll suspending on the belt-shaped photoreceptor, and is approximately in a range of about 10 to 500 μm. Other layers are the same as those of the drum.

The photosensitive layer 13 is laminated on the conductive substrate 11A.

As the photosensitive layer 13, an inorganic photosensitive layer formed of Se or a-Si, or a single-layer or multilayer (a charge generating layer 11B, a charge transport layer 11C, and the like) organic photosensitive layer may be exemplified.

Further, in order to make light incident from the exposure light source 15 of the exposure device 14 scatter more, organic particles, such as metal oxide or fluorine resin particles, having a particle diameter of tens of nanometers to several microns are preferably dispersed in the photosensitive layer.

Moreover, the thickness of the photosensitive layer 13 is determined from insulation property resistant to a charging potential in consideration of time-variant film shrinkage, and is preferably in a range of 5 to 50 μm.

The surface layer 11D preferably has impermeability to at least light that is emitted from the light source 53 of the color forming information application device 28 and is incident on the surface layer 11D, and to light that is emitted from the exposure light source 15 of the exposure device 14 and is incident on the surface layer 11D.

Here, “impermeability” means that the transmittance of emergent light with respect to light incident on the surface layer 11D (emergent light/incident light) is at least 20% or less.

The transmittance of the surface layer 11D may be set to such an extent that, when light is exposed from the outer peripheral surface of the photoreceptor 11, light having exposure energy (hereinafter, referred to as deterioration exposure energy) or more causing deterioration in the photosensitive layer 13 is prevented from reaching the photosensitive layer 13 through the surface layer 11D.

For this reason, the transmittance of the surface layer 11D is determined by the value of the deterioration exposure energy due to material design of the photosensitive layer 13, the exposure of the photoreceptor 11 by light emitted from the light source 53, or light absorption efficiency of the toner to light.

For example, when a ratio between the exposure of the photoreceptor 11 by the exposure light source 15 and the exposure of the photoreceptor 11 by the light source 53 is 1:1000, the deterioration exposure energy is about 10 times the exposure of the exposure light source 15, and the absorption efficiency of the toner to exposure light from the light source 53 is 90%, the transmittance to incident light from the exposure light source 15 may be about 10% (nontransmittance is 90%).

As such, the transmittance of the surface layer 11D may be set to such an extent that light having the deterioration exposure energy or more is prevented from reaching the photosensitive layer 13 through the surface layer 11D. The transmittance of the surface layer 11D is preferably less than 1% (nontransmittance is more than 99%) to light having a wavelength to which the photosensitive layer 13 has sensitivity.

As such, the transmittance of the surface layer 11D of the photoreceptor 11 is determined to such an extent that light having the deterioration exposure energy or more is prevented from reaching the photosensitive layer 13 through the surface layer 11D. Then, it may be possible to prevent the photosensitive layer 13 of the photoreceptor 11 from deteriorating due to light emitted from the light source 53 of the color forming information application device 28.

Moreover, the surface layer 11D preferably has impermeability to light, which is emitted from the exposure device 14 and is incident on the surface layer 11D, in order to suppress the toner formed the outer peripheral portion from being irradiated by the exposure light source 15 of the exposure device 14.

The transmittance of light of the exposure light source 15 to incident light is preferably set such that energy applied to the toner less than 10% (nontransmittance is more than 90%) is 0.01% or less of the exposure by the color forming information application unit.

The transmittance of light that is emitted from the exposure light source 15 of the exposure device 14 and then is incident onto the surface layer 11D of the photoreceptor 11 is less than 10%. Therefore, since the light emitted from the exposure device 14 does not reach the surface of the image retention medium, it may be possible to prevent the color mixture.

The material of the impermeable surface layer 11D may be selected from an organic material, an inorganic material, and a metal insofar as it has a surface resistance value such an extent that the photosensitive layer 11 may hold the electrostatic latent image and the toner image on the surface layer 11D and is the impermeable material.

A preferred surface resistance value is preferably in a range of 10⁶Ω to 10¹⁰Ω.

Moreover, for example, the surface resistance value may be calculated by applying a voltage 100 V and calculating a current value after ten seconds using a circular electrode (HR probe of Hirester IP manufactured by Mitsubishi Petrochemical Co., Ltd.: an outer diameter of a circular electrode of 16 mm; an inner diameter and an outer diameter of a ring-shaped electrodeD of 30 mm and 40 mm, respectively) under conditions of 22° C. and 55% RH.

For impermeability, the surface layer 11D may be formed of a material capable of absorbing or scattering light that is emitted from the light source 53 of the color forming information application device 28 and reaches the photoreceptor 11 and light that is emitted from the exposure light source 15 of the exposure device 14 and is incident on the surface layer 11D of the photoreceptor 11.

Specifically, as the material of the surface layer 11D, a polyurethane resin, an acrylic resin, a polycarbonate resin, or a fluorine resin, to which a conductive power, for example, SnO₂/Sb₂O₃ is added to adjust the surface resistance value, may be used.

Moreover, the material forming the surface layer 11D may include a black layer whose transmittance is adjusted by adding carbon black or the like.

The operation of the image forming apparatus 10 of the aspect of the invention, on which the photoreceptor 11 having the above-described configuration is mounted, will now be described.

As shown in FIG. 1, the photoreceptor 11 rotates in the direction of the arrow A and the outer peripheral surface of the photoreceptor 11 is uniformly charged by the charging device 12.

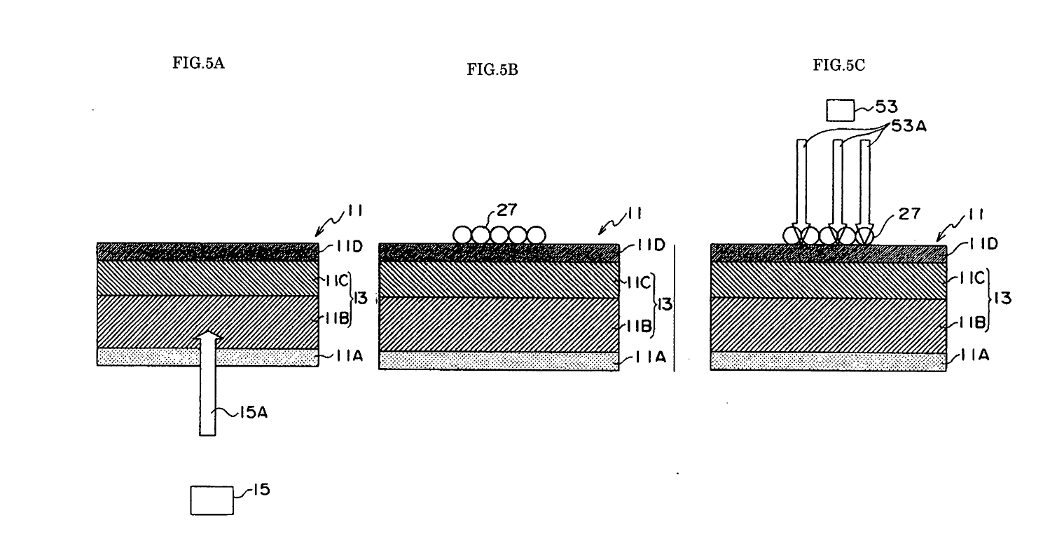

As shown in FIG. 5A, the exposure light source 15 of the exposure device 14 emits exposure light 15A in the direction from the inner peripheral surface of the photoreceptor 11 toward the outer peripheral surface. The exposure light 15A emitted from the exposure light source 15 reaches the photosensitive layer 13 through the conductive substrate 11A of the photoreceptor 11, and then the electrostatic latent image is formed in a region according to an exposure position on the outer peripheral surface of the photoreceptor 11 (that is, the surface layer 11D).

When the formation region reaches a region facing the developing device 16 by the rotation of the photoreceptor 11 having the electrostatic latent image on the outer peripheral surface, as shown in FIG. 5B, the electrostatic latent image is developed by the developing device 16, and then the toner image 27 according to the electrostatic latent image is formed on the photoreceptor 11 (in detail, on the surface layer 11D of the photoreceptor 11).

Next, when the region on the photoreceptor 11 where the toner image is formed reaches a region where the color forming information may be applied by the color forming information application device 28 with the rotation of the photoreceptor 11, as shown in FIG. 5C, the light source 53 exposes exposure light 15A having the wavelength according to the color component information of the image data onto the toner image from the outer peripheral surface of the photoreceptor 11, that is, the surface layer 11D.

The toner image having the color forming information applied by the color forming information application device 28 is transferred to the recording medium 26 by the transfer device 18 and then is heated and pressed by the fixing device 22, such that the toner image is fixed onto the recording medium 26 and simultaneously forms the colors (see FIG. 1).

As described above, according to the image forming apparatus 10 of the aspect of the invention, the photoreceptor 11 has the conductive substrate 11A, the photosensitive layer 13, and the surface layer 11D sequentially laminated from the inner peripheral surface toward the outer peripheral surface. Here, conductive substrate 11A is formed of a material having permeability to light that is emitted from the exposure light source 15 provided in the exposure device 14 and is incident on the conductive substrate 11A. The surface layer 11D is formed of a material having impermeability to light that is emitted from at least the light source 53 of the color forming information application device 28 and is incident on the surface layer 11D. In addition, the exposure light source 15 is provided on the inner peripheral surface of the photoreceptor 11, and the light source 53 is provided on the outer peripheral surface of the photoreceptor 11.

For this reason, the exposure for the application of the color forming information is performed at higher intensity than the exposure for the normal latent image formation. In the known image forming apparatus 10, it is concerned that the photoreceptor 11 is damaged by the application of the color forming information. However, according to the image forming apparatus 10 of the aspect of the invention, the outermost surface layer of the photoreceptor 11 is the impermeable surface layer 11D. Accordingly, the exposure by the exposure light source 15 that is exposed onto the photoreceptor 11 with an exposure not causing deterioration of the photosensitive layer 13 of the photoreceptor 11 may be performed from the inner peripheral of the photoreceptor 11. Further, the exposure by the light source 53 for the application of the color forming information that requires an exposure causing deterioration of the photosensitive layer 13 of the photoreceptor 11 may be performed from the outer peripheral surface of the photoreceptor 11.

Therefore, it may be possible to suppress deterioration of the photosensitive layer 13 of the photoreceptor 11 by the exposure for the application of the color forming information to the toner held on the photoreceptor 11, and to suppress deterioration of image quality in the image forming apparatus 10.

Moreover, as described above, while the exposure for the application of the color forming information needs to be performed at higher intensity than the exposure for the normal latent image formation, the exposure for the latent image formation may be performed at lower intensity than the exposure for the application of the color forming information. Accordingly, the LED may be used as the exposure light source 15.

As such, when the LED is used as the exposure light source 15, it may be possible to reduce the size of the exposure device 14 having the exposure light source 15 and to reduce the size of the photoreceptor 11 that has the exposure device 14 provided on the inner peripheral surface. Therefore, when the LED is used as the exposure light source 15, it may be possible to reduce the size of the image forming apparatus 10.

Moreover, both the exposure light source 15 and the light source 53 of the color forming information application device 28 may be semiconductor lasers.

As such, if both the exposure light source 15 and the light source 53 of the color forming information application device 28 may be semiconductor lasers, when the electrostatic latent image is formed on the photoreceptor 11 by the exposure device 14, the shape of a spot reaching the photoreceptor 11 and the shape of a spot reaching the photoreceptor 11 when the color forming information is applied to the toner image on the photoreceptor 11 by the color forming information application device 28 may be set to be substantially consistent with each other.

For this reason, it may be possible to form a high-quality image.

Moreover, light for the application of the color forming information rarely reaches a lower part of the toner developed in multiple layers on the surface layer 11D of the photoreceptor 11, and thus sufficient color forming is not performed. As a result, a color in the image after color forming may be different from a desired one.

Therefore, the surface layer 11D of the photoreceptor 11 is preferably configured to reflect light emitted from the light source 53 of the color forming information application device 28 toward the toner image again.

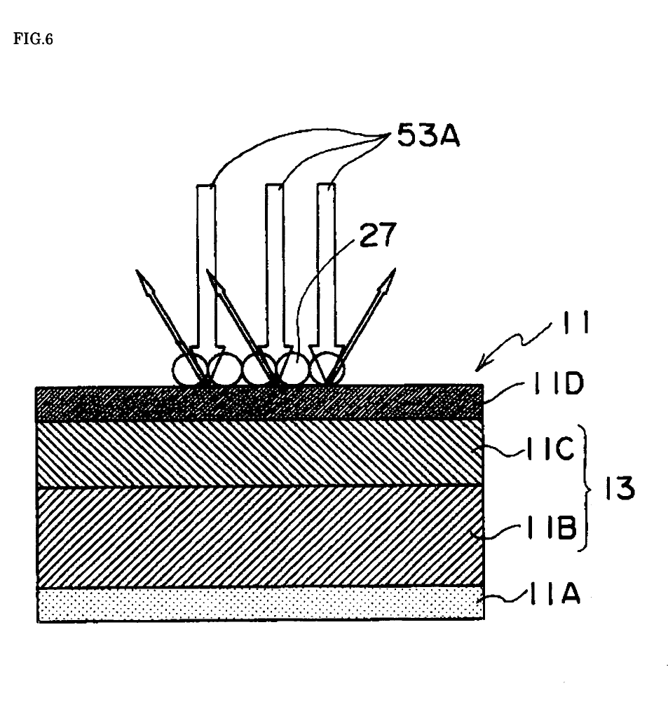

With this configuration, as shown in FIG. 6, the toner image 27 held on the surface layer 11D of the photoreceptor 11 may be exposed to exposure light 53A for the application of the color forming information, and then exposure light 53A that reaches the surface layer 11D through the toner image 27 may be reflected again and may be exposed onto the toner image 27. Accordingly, the exposure for the application of the color forming information is sufficiently performed on the toner image 27, and thus energy efficiency may be improved. Further, sufficient color formation of the toner is performed, and a color in the image may be set to a desired color.

As such, a method of forming the surface layer 11D for reflecting exposure light incident from the light source 53 is not particularly limited insofar as it can reflect light. For example, a method of forming a metal film of aluminum, silver, or the like by sputtering and forming a resistance value adjusting layer, a method of using a dielectric deposited layer as the surface layer 11D, or a method of reducing surface roughness and forming a gloss surface may be used.

Further, the reflection of light by the surface layer 11D is preferably diffused reflection in that the above-described effects may be obtained.

Moreover, reflectance of the surface layer 11D to light incident from the light source 53 is preferably 10% or more, more preferably, 50% or more from a viewpoint of the reuse of reflected light to the toner, and still more preferably, 90% or more from a viewpoint that light from the light source 53 is not transmitted to the photosensitive layer.

When the reflectance is 10% or more, energy efficiency may be improved. In particular, when the reflectance is 90% or more by coating the surface layer 11D with a metal film, energy efficiency may be further improved, and transmission of light to the photosensitive layer may be suppressed.

Moreover, when light emitted from the exposure light source 15 of the exposure device 14 is laser light, a laser beam incident on the photoreceptor is normally inclined at several degrees (4 to 13 degrees) in order to prevent return light to a monitor (Photo Detector) in a laser. In the aspect of the invention, since return light is absorbed by the toner upon the exposure for the application of the color forming information, return light may be made extremely small, and may be incident at an arbitrary angle including 0 degree.

### REFERENCE EXAMPLES

In order to check the operation of the above-described embodiment, the following experiments are preformed.

Moreover, “parts” and “%” in the following examples refer to “parts by mass” and “% by mass”, respectively.

### (Preparation of Toner)

First, the toner will be described by way of the following examples. Moreover, in the preparation of the toner, the adjustment of the light curing composition dispersion liquid and a series of preparation of the toner using the same are performed in a dark place.

### A. Non-Photochromic Toner

### (Preparation of Microcapsule Dispersion Liquid)

### —Microcapsule Dispersion Liquid (1)—

8.9 parts by mass of an electron donating colorless dye (1) formable of yellow is dissolved in 16.9 parts by mass of ethyl acetate, and 20 parts by mass of a capsule wall material (Trade Name: Takenate D-110N, manufactured by Takeda Chemical Industries Co., Ltd.) and 2 parts by mass of a capsule wall material (Trade Name: Millionate MR200, manufactured by Nippon Polyurethane Industry Co. Ltd.) are added.

The resultant solution is added in a mixture solution of 42 parts by mass of phthalated gelatin (8% by mass), 14 parts by mass of water, and 1.4 parts by mass of a sodium dodecylbenzene sulfonic acid solution (10% by mass), and is then emulsified and dispersed at 20° C., thereby obtaining an emulsified liquid. Next, 72 parts by mass of a tetraethylenepentamine aqueous solution (2.9% by mass) is added to the resultant emulsified liquid, and then is stirred and heated to 60° C. After two hours, the microcapsule dispersion liquid (1) including the electron donating colorless dye (1) in the core and having an average particle diameter of 0.5 μm is obtained.

Moreover, a glass transition temperature of a material (a material obtained by the reaction between Takenate D-110N and Millionate MR200 under approximately the same conditions as those described above) forming the outer shell of the microcapsule included in the microcapsule dispersion liquid (1) is 100° C.

### —Microcapsule Dispersion Liquid (2)—

A microcapsule dispersion liquid (2) is obtained in the same manner as the preparation of the microcapsule dispersion liquid (1), except that the electron donating colorless dye (1) is replaced with an electron donating colorless dye (2). The average particle diameter of the microcapsule in this dispersion liquid is 0.5 μm.

### —Microcapsule Dispersion Liquid (3)—

A microcapsule dispersion liquid (3) is obtained in the same manner as the preparation of the microcapsule dispersion liquid (1), except that the electron donating colorless dye (1) is replaced with an electron donating colorless dye (3). The average particle diameter of the microcapsule in this dispersion liquid is 0.5 μm.

The chemical structural formulas of the electron donating colorless dyes (1) to (3) used in the preparation of the microcapsule dispersion liquids are represented below.

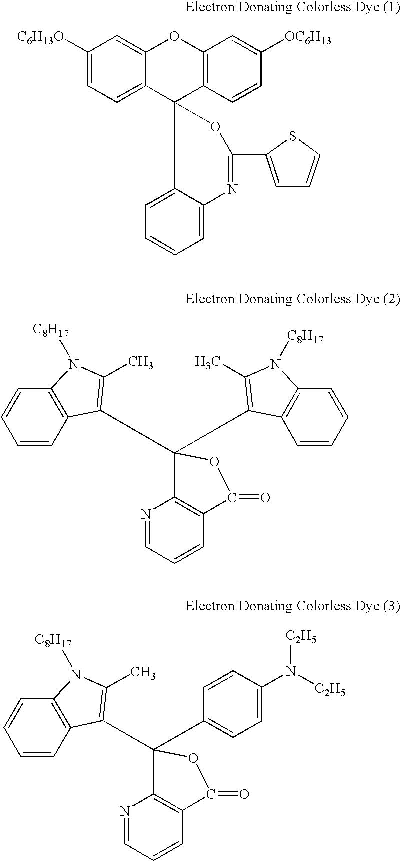

### (Preparation of Light Curing Composition Dispersion Liquid)

### —Light Curing Composition Dispersion Liquid (1)—

100.0 parts by mass of a mixture of electron accepting compounds (1) and (2) having a polymerizable group (mixture ratio 50:50) and 0.1 parts by mass of a thermopolymerization inhibitor (ALI) are dissolved in 125.0 parts by mass of isopropyl acetate (solubility in water of about 4.3%) at 42° C., thereby obtaining a mixture solution I.

18.0 parts by mass of hexaarylbiimidazole(1)[2,2′-bis(2-chlorophenyl)-4,4′,5,5′-tetraphenyl-1,2′-biimidazole] and 0.5 parts by mass of a nonionic organic dye, and 6.0 parts by mass of an organic boron compound are added to the mixture solution I and dissolved at 42° C., thereby obtaining a mixture solution II.

The mixture solution II is added to a mixture solution of 300.1 parts by mass of a gelatin aqueous solution (8% by mass) and 17.4 parts by mass of a surfactant (1) aqueous solution (10% by mass) and emulsified using a homogenizer (manufactured by Nippon Seiki Co., Ltd) at 10000 rpm for five minutes. Then, a desolvation treatment is performed at 40° C. for three hours, thereby obtaining the light curing composition (1) having a solid content of 30% by mass.

Moreover, the structural formulas of the electron accepting compound (1) having a polymerizable group, the electron accepting compound (2) having a polymerizable group, the thermopolymerization inhibitor (ALI), hexaarylbiimidazole (1), the surfactant (1), the nonionic organic dye, and the organic boron compound used in the preparation of the light curing composition dispersion liquid (1) are represented below.

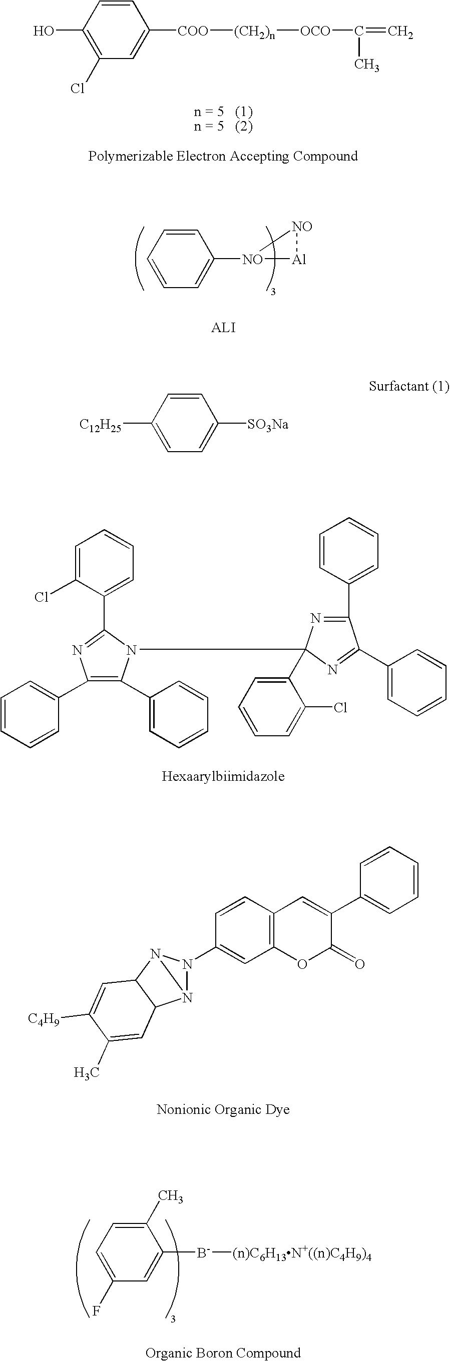

### —Light Curing Composition Dispersion Liquid (2)—

5 parts of mass of the following electron accepting compound (3) having a polymerizable group is added to a mixture solution of 0.6 parts by mass of the following organic borate compound (I), 0.1 parts by mass of the above-described spectral sensitization dye-based borate compound (I), 0.1 parts by mass of the following additive (1) for high sensitivity, and 3 parts by mass of isopropyl acetate (solubility in water of about 4.3%).

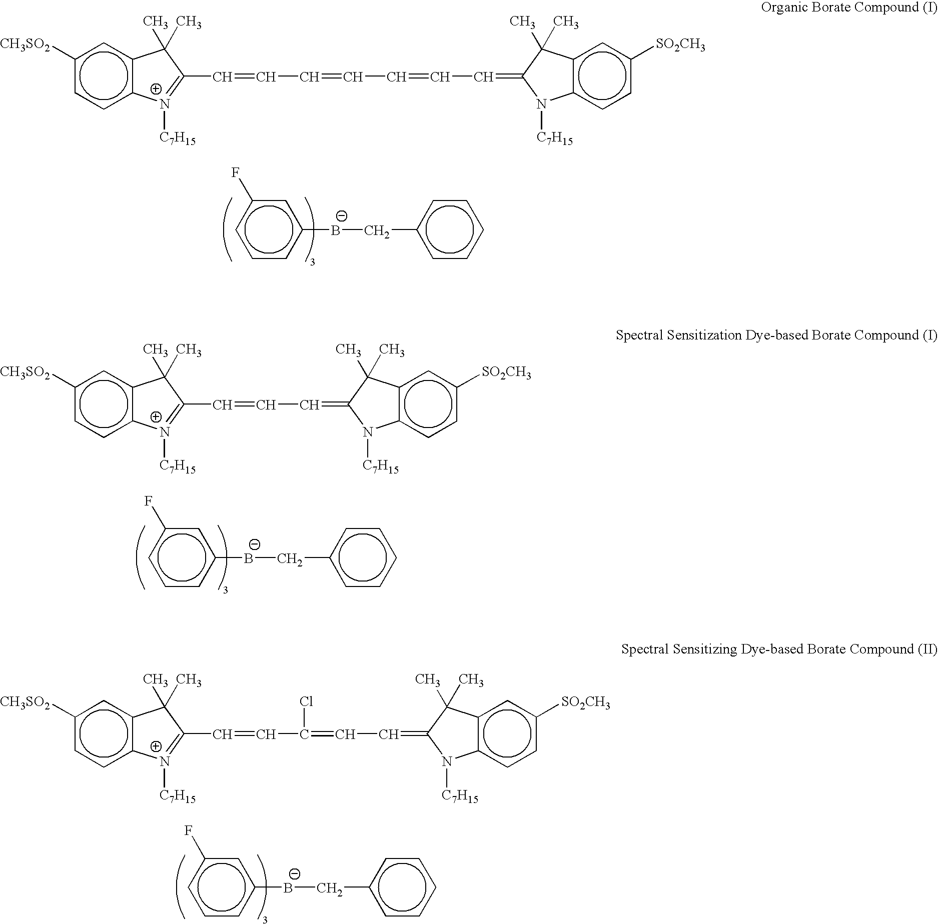

The resultant solution is added to a mixture solution of 13 parts by mass of a gelatin aqueous solution (13% by mass), 0.8 parts by mass of the following surfactant (2) aqueous solution (2% by mass), and 0.8 parts by mass of the following surfactant (3) aqueous solution (2% by mass), and emulsified using the homogenizer (manufactured by Nippon Seiki Co., Ltd) at 10000 rpm for five minutes, thereby obtaining the light curing composition dispersion liquid (2).

Moreover, the structural formulas of the electron accepting compound (3) having a polymerizable group, the additive (1), the surfactant (2), and the surfactant (3) used in the preparation of the light curing composition dispersion liquid (2) are represented below.

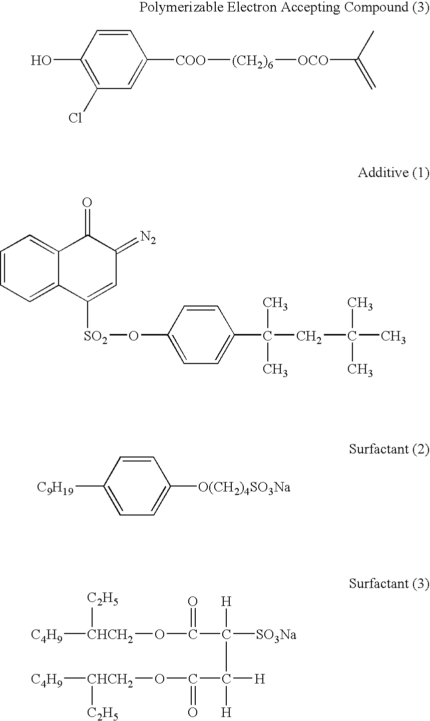

### —Light Curing Composition Dispersion Liquid (3)—

A light curing composition dispersion liquid (3) is obtained in the same manner as the preparation of the light curing composition dispersion liquid (2), except that the spectral sensitization dye-based borate compound (I) is replaced with 0.1 parts by mass of the above-described spectral sensitization dye-based borate compound (II).

### (Preparation of Resin Particle Dispersion Liquid)

styrene: 460 parts by mass
n butyl acrylate: 140 parts by mass
acrylic acid: 12 parts by mass
dodecanethiol: 9 parts by mass

These components are mixed and dissolved to prepare a solution. Subsequently, this solution is added to a material obtained by dissolving 12 parts by mass of an anionic surfactant (Dowfax, manufactured by Rhodia Inc.) in 250 parts by mass of an ion-exchange water, and then is dispersed and emulsified in a flask, thereby obtaining an emulsified liquid (a monomeric emulsified liquid A).

Further, 1 parts by mass of an anionic surfactant (Dowfax, manufactured by Rhodia Inc.) is dissolved in 555 parts by mass of an ion-exchange water and is fed into a polymerization flask. The polymerization flask is closed airtight, and a reflux tube is provided. Then, the polymerization flask is heated to 75° C. by a water bath while injecting nitrogen and stirring at a low speed and held.

Next, a solution, in which 9 parts by mass of an ammonium persulfate is dissolved in 43 parts by mass of an ion-exchange water, drips into the polymerization flask through a quantitative pump for 20 minutes, and then the monomeric emulsified liquid A also drips through the quantitative pump for 200 minutes.

Subsequently, while continuously stirring at a low speed, the polymerization flask is held at 75° C. for three hours, and then the polymerization ends.

As a result, resin particles having a particle median size of 210 nm, a glass transition point of 51.5° C., a weight-average molecular weight of 31000, and a solid content of 42% are obtained.

### (Manufacture of Toner 1 (Color Forming Portion Dispersion Structure Type))

### —Preparation of Photosensitive/Heat-Sensitive Capsule Dispersion Liquid (1)—

microcapsule dispersion liquid (1): 150 parts by mass
light curing composition dispersion liquid (1): 300 parts by mass
polyaluminum chloride: 0.20 parts by mass
ion-exchange water: 300 parts by mass

A solution is obtained by adding nitric acid to a raw solution in which the above-described components are mixed, and is adjusted to pH 3.5, and is sufficiently mixed and dispersed by a homogenizer (Ultratalax T50, manufactured by IKA). Then, the solution is fed to a flask, is heated to 40° C. by a heating oil bath while being stirred by a three-one motor, and is held at 40° C. for 60 minutes. Next, 300 parts by mass of a resin particle dispersion liquid is further added, and stirring is performed at 60° C. for two hours at a low speed. Accordingly, the photosensitive/thermosensitive capsule dispersion liquid (1) is obtained.

Moreover, the volume-average particle diameter of the photosensitive/thermosensitive capsule dispersed into the dispersion liquid is 3.53 μm. Further, spontaneous color forming of the dispersion liquid is not observed upon the adjustment of the dispersion liquid.

### —Preparation of Photosensitive/Heat-Sensitive Capsule Dispersion Liquid (2)—

microcapsule dispersion liquid (2): 150 parts by mass
light curing composition dispersion liquid (2): 300 parts by mass
polyaluminum chloride: 0.20 parts by mass
ion-exchange water: 300 parts by mass

A photosensitive/thermosensitive capsule dispersion liquid (2) is obtained in the same manner as the preparation of the photosensitive/thermosensitive capsule dispersion liquid (1), except that the above-described components are used as a raw solution.

Moreover, the volume-average particle diameter of the photosensitive/thermosensitive capsule dispersed into the dispersion liquid is 3.52 μm. Further, spontaneous color forming of the dispersion liquid is not observed upon the adjustment of the dispersion liquid.

### —Preparation of Photosensitive/Heat-Sensitive Capsule Dispersion Liquid (3)—

microcapsule dispersion liquid (3): 150 parts by mass
light curing composition dispersion liquid (3): 300 parts by mass
polyaluminum chloride: 0.20 parts by mass
ion-exchange water: 300 parts by mass

A photosensitive/thermosensitive capsule dispersion liquid (3) is obtained in the same manner as the preparation of the photosensitive/thermosensitive capsule dispersion liquid (1), except that the above-described components are used as a raw solution.

Moreover, the volume-average particle diameter of the photosensitive/thermosensitive capsule dispersed into the dispersion liquid is 3.47 μm. Further, spontaneous color forming of the dispersion liquid is not observed upon the adjustment of the dispersion liquid.

### —Manufacture of Toner—

photosensitive/thermosensitive dispersion liquid (1): 750 parts by mass
photosensitive/thermosensitive dispersion liquid (2): 750 parts by mass
photosensitive/thermosensitive dispersion liquid (3): 750 parts by mass

A solution obtained by mixing the above-described components is fed to a flask, is heated to 42° C. by a heating oil bath while the flask is stirred, and is held at 42° C. for 60 minutes. Then, 100 parts by mass of a resin particle dispersion liquid is added, and stirring is performed at a low speed.

Subsequently, pH in the flask is adjusted to 5.0 by 0.5 mol/liter of a sodium hydroxide aqueous solution, and the flask is heated to 55° C. while stirring is continuously performed. During temperature rising, normally, pH in the flask is lowered to 5.0 or less. Here, the sodium hydroxide aqueous solution further drip, and pH is held so as not to be 4.5 or less. This state is held at 55° C. for three hours.

After the reaction is completed, cooling, filtering, and sufficient washing by the ion-exchange water are preformed, and then solid-liquid separation is performed by Nutsche suction filtration. Then, the solution is dispersed into 3 liters of an ion-exchange water at 40° C. in a 5-liter beaker again, then is stirred at 300 rpm for 15 minutes, and subsequently is washed. The washing operation is repeated five times, and solid-liquid separation is performed by the Nutsche suction filtration. Next, vacuum freeze-drying is performed for 12 hours, thereby obtaining toner particles in which the photosensitive/thermosensitive capsules are dispersed into a styrene-based resin. When the particle diameter of the toner particle is measured by a Coulter counter, the volume-average particle diameter D50v is 15.2 μm. Subsequently, 1.0 parts by mass of hydrophobic silica (TS720, manufactured by Cabot Corporation) is added to 50 parts by mass of the toner particles, and they are mixed by a sample mill, thereby obtaining an external additive toner 1.

### B. Photochromic Toner

### (Preparation of Microcapsule Dispersion Liquid)

### —Microcapsule Dispersion Liquid (1)—

A solution is prepared by dissolving 12.1 parts by mass of the electron donating colorless dye (1) into 10.2 parts by mass of ethyl acetate and adding 12.1 parts by mass of dicyclohexyl phthalate, 26 parts by mass of Takenate D-110N (manufactured by Takeda Chemical Industries Co., Ltd.) and 2.9 parts by mass of Millionate MR200 (manufactured by Nippon Polyurethane Industry Co. Ltd.).

Subsequently, this solution is added to a mixture solution of 5.5 parts by mass of polyvinylalcohol and 73 parts by mass of water and is emulsified and dispersed at 20° C., thereby obtained an emulsified liquid having an average particle diameter of 0.5 μm. 80 parts by mass of water is added to the resultant emulsified liquid, and heating is performed to 60° C. while stirring. After two hours, the microcapsule dispersion liquid (1) into which microcapsules having the electron donating colorless dye (1) as a core material is obtained.

Moreover, a glass transition temperature of a material (a material obtained by the reaction among dicyclohexyl phthalate, Takenate D-110N, and Millionate MR200 under approximately the same conditions as those described above) forming the outer shell of the microcapsule included in the microcapsule dispersion liquid (1) is 130° C.

### —Microcapsule Dispersion Liquid (2)—

A microcapsule dispersion liquid (2) is obtained in the same manner as the preparation of the microcapsule dispersion liquid (1), except that the electron donating colorless dye (1) is replaced with the electron donating colorless dye (2).

### —Microcapsule Dispersion Liquid (3)—

A microcapsule dispersion liquid (3) is obtained in the same manner as the preparation of the microcapsule dispersion liquid (1), except that the electron donating colorless dye (1) is replaced with the electron donating colorless dye (3).

### (Preparation of Light Curing Composition Dispersion Liquid)

### —Light Curing Composition Dispersion Liquid (1)—

9 parts of an electron accepting compound (1) and 7.5 parts of a trimethylolpropane triacrylate monomer (trifunctional acrylate, a molecular weight of about 300) are added to a solution obtained by dissolving 1.62 parts of a photopolymerization initiator (1-a) and 0.54 parts of a photopolymerization initiator (1-b) in 4 parts of ethyl acetate.

The resultant solution is added to a mixture solution obtained by mixing 19 parts of a PVA (polyvinylalcohol) aqueous solution (15%), 5 parts of water, 0.8 parts of a surfactant (1) aqueous solution (2%), and 0.8 parts of a surfactant (2) aqueous solution (2%), and is emulsified by the homogenizer (manufactured by Nippon Seiki Co., Ltd) at 8000 rpm for seven minutes. As a result, the light curing composition (1) is obtained as an emulsified liquid.

### —Light Curing Composition Dispersion Liquid (2)—

A light curing composition dispersion liquid (2) is obtained in the same manner as the preparation of the light curing composition dispersion liquid (1), except that the photopolymerization initiators (1-a) and (1-b) are replaced with 0.08 parts of photopolymerization initiator (2-a), 0.18 parts of photopolymerization initiator (2-b), and 0.18 parts of photopolymerization initiator (2-c).

### —Light Curing Composition Dispersion Liquid (3)—

A light curing composition dispersion liquid (3) is obtained in the same manner as the preparation of the light curing composition dispersion liquid (1), except that the photopolymnerization initiator (2-b) used in the light curing composition dispersion liquid(2) is replaced with a photopolymerization initiator (3-b).

Moreover, the chemical structural formulas of the photopolymerization initiators (1-a), (1-b), (2-a), (2-b), (2-c), and (3-b), the electron accepting compound (1), and the surfactants (1) and (2) used in the preparation of the light curing composition dispersion liquids are represented below.

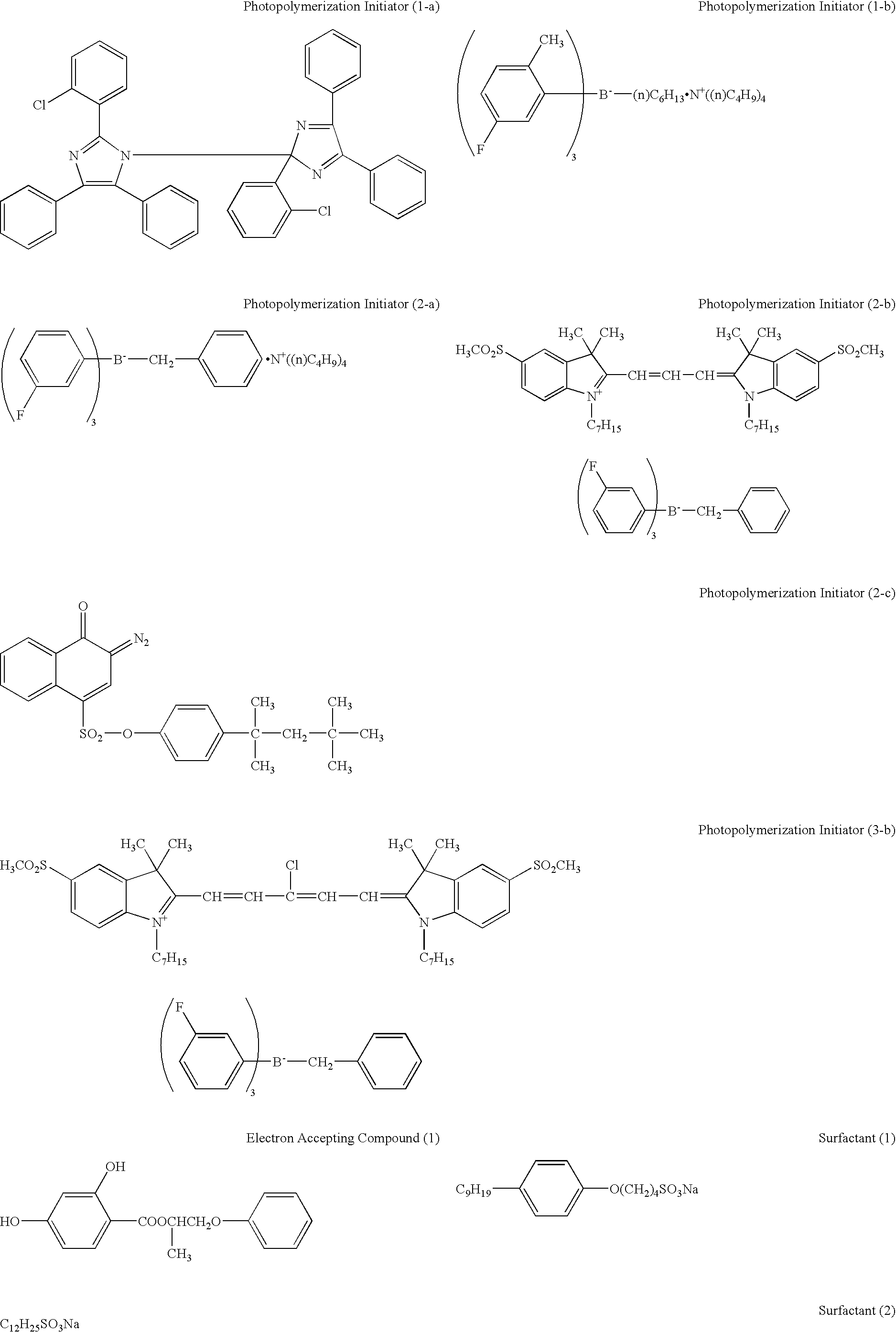

### —Preparation of Resin Particle Dispersion Liquid (1)—

styrene: 360 parts
n butyl acrylate: 40 parts
acrylic acid: 4 parts
dodecanethiol: 24 parts
carbon tetrabromide: 4 parts

A solution obtained by mixing and dissolving the above-described components is dispersed and emulsified into a solution obtained by dissolving 6 parts of a nonionic surfactant (Nonipol 400, manufactured by Sanyo Chemical Industries, Ltd.) and 10 parts of an anionic surfactant (Neogen SC, manufactured by Daiichi Kogyo Seiyaku Co., Ltd) in 560 parts of an ion-exchange water in a flask, and mixing is performed at a low speed for ten minutes. Then, 50 parts of an ion-exchange water in which 4 parts of ammonium persulfate is dissolved is injected therein.

Subsequently, after nitrogen substitution in the flask is performed, the content is heated to 70° C. by an oil bath while the flask is stirred, and emulsion polymerization is continued for five hours. Accordingly, the resin particle dispersion liquid (1) (resin particle concentration: 30%) in which resin particles having the volume-average particle diameter of 200 nm, the glass transition temperature of 50° C., the weight-average molecular weight Mw of 16200, and gravity of 1.2 are dispersed is obtained.

### —Preparation of Photosensitive/Heat-Sensitive Capsule Dispersion Liquid (1)—

24 parts of microcapsule dispersion liquid (1)
232 parts of light curing composition dispersion liquid (1)

These are sufficiently mixed and dispersed in a round-shaped stainless flask by Ultratalax T50 manufactured by IKA.

Subsequently, the mixture is adjusted to pH 3 by nitric acid, 0.20 parts of polyaluminum chloride is added thereto, and then a dispersion operation is continued using Ultratalax at 6000 rpm for 10 minutes. The flask is heated to 40° C. by the heating oil bath while being stirred at a low speed.

Here, 60 parts of the resin particle dispersion liquid (1) is slowly added.

Accordingly, the photosensitive/thermosensitive capsule dispersion liquid (1) is obtained. Moreover, the volume-average particle diameter of the photosensitive/thermosensitive capsule dispersed into the dispersion liquid is about 2 μm. Further, spontaneous color forming of the resultant dispersion liquid is not observed.

### —Preparation of Photosensitive/Thermosensitive Capsule Dispersion Liquid (2)—

A photosensitive/thermosensitive capsule dispersion liquid (2) is fabricated in the same manner as the photosensitive/thermosensitive capsule (1), except that the microcapsule dispersion liquid (1) is replaced with the microcapsule dispersion liquid (2), and the light curing composition dispersion liquid (1) is replaced with the light curing composition dispersion liquid (2). Moreover, the volume-average particle diameter of the photosensitive/thermosensitive capsule dispersed into the dispersion liquid is about 2 μm. Further, spontaneous color forming of the resultant dispersion liquid is not observed.

### —Preparation of Photosensitive/Thermosensitive Capsule Dispersion Liquid (3)—

A photosensitive/thermosensitive capsule dispersion liquid (3) is fabricated in the same manner as the photosensitive/thermosensitive capsule (1), except that the microcapsule dispersion liquid (1) is replaced with the microcapsule dispersion liquid (3), and the light curing composition dispersion liquid (1) is replaced with the light curing composition dispersion liquid (3). Moreover, the volume-average particle diameter of the photosensitive/thermosensitive capsule dispersed into the dispersion liquid is about 2 μm. Further, spontaneous color forming of the resultant dispersion liquid is not observed.

### (Manufacture of Toner 2 (Color Forming Portion Dispersion Structure Type))

### —Manufacture of Toner—

photosensitive/thermosensitive capsule (1): 80 parts
photosensitive/thermosensitive capsule (2): 80 parts
photosensitive/thermosensitive capsule (3): 80 parts
resin particle dispersion liquid (1): 80 parts

These are sufficiently mixed and dispersed in a round-shaped stainless flask by Ultratalax T50 manufactured by IKA.

Next, 0.1 parts of polyaluminum chloride is added to the mixture, and a dispersion operation is continued by Ultratalax at 6000 rpm for ten minutes. The flask is heated to 48° C. by the heating oil bath while being stirred. After holding at 48° C. for 60 minutes, 20 parts of the resin particle dispersion liquid (1) is added thereto at a low speed.

Subsequently, after pH in the system is adjusted to 8.5 by 0.5 mol/l of sodium hydroxide, the stainless flask is sealed. Then, the flask is heated to 55° C. while being continuously stirred using a magnetic seal, and is held for 10 hours.

After the reaction is completed, cooling, filtering, and sufficient washing by the ion-exchange water are preformed, and then solid-liquid separation is performed by Nutsche suction filtration. Then, the solution is dispersed into 1 liter of an ion-exchange water at 40° C., then is stirred and washed at 300 rpm for 15 minutes.

This process is repeated five times and, when pH of the filtered liquid becomes 7.5 and electrical conductivity becomes 7.0 μS/cm, solid-liquid separation is performed by Nutsche suction filtration using a No.5A filter paper. Next, vacuum drying is performed for 12 hours, thereby obtaining toner particles in which three kinds of photosensitive/thermosensitive capsules are dispersed in a base material.

When the particle diameter at that time is measured by a Coulter counter, the volume-average particle diameter D50v is about 15 μm. Further, spontaneous color forming by the resultant dispersion liquid is not observed.

Next, 100 parts of the toner (1), 0.3 parts of hydrophobic titania that is subjected to a surface treatment by n-decyltrimethoxysilane and has an average particle diameter of 15 nm, and 0.4 parts of hydrophobic silica (NY50, manufactured by Nippon Aerosil Co., Ltd.) having an average particle diameter of 30 nm are blended using a Henschel mixer at a peripheral speed of 32 m/s for 10 minutes. Then, coarse particles are removed using a sieve having an opening of 45 μm, thereby obtaining an external additive toner 2 a toner having an external additive added thereto.

### <Manufacture of Developer>

Next, the external additive toners 1 and 2 are weighed using ferrite carriers, the surface of the carrier core of which is covered with polymethylmetacrylate (manufactured by Soken Chemical & Engineering Co., Ltd.), having an average particle diameter of 50 μm (the used amount of polymethylmetacrylate to the total mass of the carriers: 1% by mass) such that the toner concentration becomes 5% by mass. Then, both are stirred and mixed in a ball mill for five minutes and developers (1) and (2) are prepared. As described above, the developer (1) is a developer using the nonphotochromic toner, and the developer (2) is a developer using the photochromic toner.

### (Image Formation)

The image forming apparatus shown in FIG. 1 is prepared.

As for the photoreceptor 11, a multilayer organic photosensitive layer including a charge generating layer formed of gallium phthalocyanine chloride and the charge transport layer formed of N,N′-diphenyl-N,N′-bis(3-methylphenyl)-[1,1′]biphenyl-4,4′-diamine and having a thickness of 25 μm is coated and formed around an aluminum drum, and then acryl-modified polyurethane is coated and formed to have a thickness of 2 μm by a dip method as the surface layer 11D. A scorotron is used as the charging device 12.

As the exposure device 14, an LED image bar having a wavelength of 780 nm is used such that the latent image may be formed with resolution 600 dpi. The developing device 16 includes a metal sleeve for two-component magnetic brush development that can perform reverse development.

The color forming information application device 28 is an LED image bar having resolution of 600 dpi that can irradiate light having peak wavelengths of 405 nm (reference exposure: 0.2 mJ/cm²), 532 nm (reference exposure: 0.2 mJ/cm²), and 657 nm (reference exposure: 0.4 mJ/cm²). The transfer device 18 has a semiconductive roll formed by coating a conductive elastic member onto the outer periphery of a conductive core as a transfer roll. The conductive elastic member is formed by dispersing two kinds of carbon black of Ketjen Black and Thermal Black into an incompatible blend substance obtained by mixing NBR and EPDM. Roll resistance is 10^{8.5} Ωcm and Asker C hardness is 35 degrees.

As the fixing device 22, a fixer that is used in DPC 1616 manufactured by Fuji Xerox Co., Ltd is used. The fixing device 22 is disposed at a position spaced by 30 cm from a point for the application of the color forming information. Further, as the light irradiation device 24, high-luminance view box including three wavelengths of the color forming information application device is used, and the irradiation width is set to 5 mm.

The printing conditions of the image forming apparatus having the above-described configuration are set as follows.
Linear Speed: 10 mm/sec
Charging Condition: A voltage of −400 V is applied to the screen of the scorotron and a direct current voltage of −6 kV is applied to the wire. At that time, the surface potential of the photoreceptor becomes −400 V.
Developing Bias: A square wave of an alternating current voltage Vpp 1.2 kV (3 kHz) is superimposed on a direct current voltage −330 V.
Developer Contact Condition: A peripheral speed ratio (developing roll/photoreceptor) is set to 2.0, a developing gap is set to 0.5 mm, the weight of the developer on the developing roll is set to 400 g/m², and the developed amount of the toner on the photoreceptor is set to 5 g/m² by the solid image.
Transfer Bias: A direct current voltage of +800 V is applied.
Fixing Temperature: The surface temperature of the fixing roll is set to 180° C.
Light Source of Light Irradiation Device: Y Light Irradiating Section 51Y: Exposure with a light of 405 nm. M Light Irradiating Section 51M: Exposure with a light of 535 nm. C Light Irradiating Section 51C: Exposure with a light of 657 nm.

Under the above-described condition, each of the developer (1) and the developer (2) is loaded to the developing unit, and then processing of successively forming an A4-size image on 100000 sheets with a 10% density is performed. As a result, whichever developer is used, deterioration in image quality is not observed after successive image formation of 100000 sheets. This may be thought to be because deterioration of the photoreceptor from exposure for the application of the color forming information is suppressed.

All publications, patent applications, and technical standards mentioned in this specification are herein incorporated by reference to the same extent as if each individual publication, patent application, or technical standard was specifically and individually indicated to be incorporated by reference.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image retention medium that has a conductive substrate, a photosensitive layer, and a surface layer sequentially laminated from an inner peripheral surface toward an outer peripheral surface;
a charging unit that charges the outer peripheral surface of the image retention medium at a predetermined charging potential;
a latent image forming unit that has a first light source that emits light in a direction from the inner peripheral surface of the image retention medium toward the outer peripheral surface, and exposes from the inner peripheral surface of the image retention medium charged by the charging unit to the light emitted from the first light source so as to form an electrostatic latent image on the outer peripheral surface of the image retention medium;
a developing unit that develops the electrostatic latent image formed on the outer peripheral surface of the image retention medium with a toner so as to form a toner image on the outer peripheral surface of the image retention medium, the toner holding a color forming state or a non-color forming state by the application of color forming information by light;
a color forming information application unit that has a second light source that emits light in a direction from the outer peripheral surface of the image retention medium toward the inner peripheral surface, and exposes the toner image formed on the outer peripheral surface of the image retention medium to the light emitted from the second light source so as to apply color forming information to the toner image;
a transfer unit that transfers the toner image to a recording medium;
a fixing unit that fixes the toner image transferred to the recording medium onto the recording medium;
a color forming unit that forms color of the toner image applied with the color forming information; and
the conductive substrate being substantially permeable to at least the light emitted from the first light source, and the surface layer being substantially impermeable to at least the light emitted from the second light source.

2. The image forming apparatus according to claim 1,
wherein the surface layer is substantially impermeable to the light emitted from the first light source.

3. The image forming apparatus according to claim 1,
wherein the surface layer reflects the light emitted from the second light source.

4. The image forming apparatus according to claim 1,
wherein the first light source is an light emitting diode (LED).

5. The image forming apparatus according to claim 1,
wherein the second light source emits laser light.

6. The image forming apparatus according to claim 1,
wherein the first light source and the second light source emit laser light.

7. The image forming apparatus according to claim 1,
wherein when exposed to light having a prescribed wavelength corresponding to a color to be formed or a color not to be formed the toner holds a state that the color corresponding to a wavelength of the exposed light can be formed or a state that the color cannot be formed, and
the second light source emits light having the prescribed wavelength corresponding to the color to be formed or the color not to be formed.

8. The image forming apparatus according to claim 1,
wherein the first light source emits light having a wavelength different from a wavelength of light emitted from the second light source.

9. The image forming apparatus according to claim 1,
wherein the color forming unit is provided integrally with the fixing unit.

10. The image forming apparatus according to claim 1, further comprising:
a post-fixing light irradiating unit that irradiates light onto the recording medium after fixing.

11. An image forming apparatus comprising:
an image retention medium that has a conductive substrate, a photosensitive layer, and a surface layer sequentially laminated from an inner peripheral surface toward an outer peripheral surface;
a charging unit that charges the outer peripheral surface of the image retention medium at a predetermined charging potential;
a latent image forming unit that has a first light source that emits light in a direction from the inner peripheral surface of the image retention medium toward the outer peripheral surface, and exposes from the inner peripheral surface of the image retention medium charged by the charging unit to the light emitted from the first light source so as to form an electrostatic latent image on the outer peripheral surface of the image retention medium;
a developing unit that develops the electrostatic latent image formed on the outer peripheral surface of the image retention medium with a toner so as to form a toner image on the outer peripheral surface of the image retention medium;
a color forming information application unit that has a second light source that emits light in a direction from the outer peripheral surface of the image retention medium toward the inner peripheral surface, and exposes the toner image formed on the outer peripheral surface of the image retention medium to the light emitted from the second light source so as to apply color forming information to the toner image;
a transfer unit that transfers the toner image to a recording medium;
a fixing unit that fixes the toner image transferred to the recording medium onto the recording medium;
a color forming unit that forms color of the toner image applied with the color forming information; and
the conductive substrate being substantially permeable to at least the light emitted from the first light source, and the surface layer being substantially impermeable to at least the light emitted from the second light source;
the toner having a first component and a second component that exist separated from each other and form a color when reacted each other, and has a light curing composition that includes either the first component or the second component, and by the application of the color forming information by light causing the light curing composition to hold a cured or non-cured state the toner holds the state that a color can be formed or the state that a color can not be formed.
